(19) United States
(12) Patent Application Publication
(10) Pub. No.: US 2026/0128920 A1
(43) Pub. Date: May 7, 2026

(54) METHOD AND SYSTEM FOR ASSURING CONFERENCE SECURITY AND MULTIMEDIA SESSION SETUP INCLUDING IMPROVEMENT OF SESSION INITIATION PROTOCOL IN INTERNET PROTOCOL NETWORK

(71) Applicant: SK Planet Co., Ltd., Seongnam-si (KR)

(72) Inventor: Sunghyun YOON, Seoul (KR)

(21) Appl. No.: 19/377,066

(22) Filed: Nov. 3, 2025

(30) Foreign Application Priority Data
Nov. 7, 2024 (KR) 10-2024-0156904
Dec. 10, 2024 (KR) 10-2024-0183181
Dec. 10, 2024 (KR) 10-2024-0183199

(51) Int. Cl. H04L 12/18

(52) U.S. Cl. CPC H04L 12/1827; H04L 12/1831

(57) ABSTRACT

The present invention relates to improving the security environment in IP networks and some standardized protocol relevant to the establishment of multimedia sessions by an artificial intelligence (AI) technology. The first aspect of the present invention is to reinforce the security level on the meeting contents that may be shared among or between the meeting participants by using the AI technology. The second aspect of the present invention is to overcome a session establishment failure due to at least one item included in the session description protocol (SDP) when setting up a multimedia session between at least two terminals by using the AI technology. And the third aspect of the present invention is to introduce a new parameter to improve the max-forward function of the session initiation protocol (SIP), which can be viewed as de facto standard in audio or video teleconferencing in IP networks.

### CROSS REFERENCE TO RELATED APPLICATIONS

This application claims priority to Korean Patent Applications No. 10-2024-0156904, filed on Nov. 7, 2024, Korean Patent Applications No. 10-2024-0183181, filed on Dec. 10, 2024, and Korean Patent Applications No. 10-2024-0183199, filed on Dec. 10, 2024, which are incorporated by reference herein in their entirety.

### BACKGROUND

### 1. Field of the Invention

The present invention relates to a system and method to improve the security environment in IP networks and some standardized protocol relevant to the establishment of multimedia sessions by an artificial intelligence (AI) technology. The present invention has at least three aspects. The first aspect of the present invention is to reinforce the security level on the meeting contents that may be shared among or between the meeting participants by using the AI technology. The second aspect of the present invention is to overcome a session establishment failure due to at least one item included in the session description protocol (SDP) when setting up a multimedia session between at least two terminals by using the AI technology. And the third aspect of the present invention is to introduce a new parameter to improve the max-forward function of the session initiation protocol (SIP), which can be viewed as de facto standard in audio or video teleconferencing in IP networks.

### 2. Description of the Related Art

Thanks to recent advances in IT (Information Technology), ICT (Information and Communications Technology), and wired and wireless network technology, various devices that support meetings are being developed and commercialized. For example, a so-called speakerphone that combines a microphone and a speakerphone can be found easily in a conference room at a company. By using the speakerphone, when there is a meeting including multiple people in a company and a third party, all meeting participants can listen to what the third party is saying through the speakerphone. If one of the meeting participants speaks, the other meeting participants in the conference room and the third party participating in the meeting remotely may almost simultaneously hear what is spoken during the meeting.

Nowadays, in order to support video conferencing, for example, a large screen that can transmit and play multimedia data, which could be the contents of the meeting, is installed in the center of the conference room, and a microphone is often provided in the seat where the meeting participants are seated. By using the on/off button of the microphone, each participant can speak if necessary. In addition, there are audio recording devices to record sounds generated inside the conference room, cameras to film the meeting situation, and facial or fingerprint reader machines to allow or restrict access to the conference room.

As the telecommuting becomes more common, it has become possible for employees or meeting participants to attend multi-party video conferences online by using personal notebooks, smartphones, smart pads, etc. These smart devices are provided with many applications developed for such smart teleconferencing. However, sometimes the conference organizer may not ask the participants to manipulate their smart devices at the organizer's will because some participants may be participating in the conference from home. Thus, depending on the participant's specific situation, the meeting organizer may have to respect the participant's privacy more than when they have onsite meetings at a company.

The concept of “meeting” or “conference” is expanding. Meetings do not have to be business meetings. In fact, university lectures are often provided online, and two individuals can make a video call anywhere any time. There is no reason not to exclude these lectures or friends' talking from the scope of a meeting. Thanks to the aforementioned advancement of ICT technology and the wide spread of smartphones, it is no longer meaningful to distinguish whether a conversation between two or more people is a “meeting” or not just by who the meeting participants are or what the meeting agenda is. In short, it can be understood that the current era is in which the concept of meetings is greatly expanded.

On the one hand, the offline meeting environment is becoming more advanced, and on the other hand, as online meetings become as important in daily life as offline meetings, the importance of meeting security is becoming more prominent. In other words, not only online meetings but also offline meetings are increasingly carrying devices that can be easily linked to the outside world through the network (e.g., using smartphones, laptops, etc. to send secure emails to external third parties), and if the audio, video, and electronic documents (meeting materials, lecture materials, slides, etc.) shared during the meeting contain matters that may infringe on personal privacy or be related to corporate trade secrets, the possibility of the content being easily shared with an unspecified number of people or malicious third parties is also increasing. In other words, as the concept of conferencing expands, the security of conferencing is not necessarily related to protecting the company's cutting-edge technology. For example, if the minutes of an apartment residents' meeting are shared online due to the organizer's mistake, it would be reasonable to understand that this is a problem related to the security of the meeting.

As the concept of meetings itself expands and the technology that enables meetings advances by leaps and bounds, there is a need to develop technology that can automatically block or control the possible leakage of important or sensitive meeting contents.

On the other hand, as the offline meeting environment becomes more advanced and online meetings become as important in daily life as offline meetings, there is a growing possibility that the specifications and performance of the devices used by meeting participants might not match or interoperate with each other when conducting meetings using the network. If the media type or media format to be used for multimedia meetings is a media type or media format that is not supported by the terminal of the person currently participating in the meeting. However, replacing participants' smart devices to better ones solely to attend a meeting would be somewhat impractical and inefficient in terms of cost.

On the other hand, there are several international standard protocols for conferencing using the internet. For example, the Session Initiation Protocol (SIP) is stipulated in the RFC-3261 document issued in June 2002 by the International Internet Engineering Task Force (IETF). Since then, SIP has become the de facto international standard technology for creating online sessions between two terminal devices for remote conferencing using telephone networks or internet networks. The SIP protocol is the most widely used Internet Protocol Version 4 (IPv4) and IPv6 (Internet Protocol Version 6).

As mentioned above, for the aforementioned various online meetings, the SIP protocol has now become the de facto standard. However, SIP itself does not offer any special alternatives regarding meeting security, and as a result, the header used for SIP communication is sometimes set as a default value without much consideration for security. Among them, it is known that max-forward is a header field that can be related to security, but there is no special improvement other than the default value mentioned above.

### SUMMARY OF THE INVENTION

The first aspect of the present invention is intended to respond to all or at least part of the technical requirements mentioned above, and the technical task is to further upgrade the security level of the meeting compared to the conventional technology by incorporating AI technology into the server and database used for both offline and online meetings.

In addition, the second aspect of the present invention is a technical task to install an AI SDP application on a terminal participating in a conference, and to implement an algorithm that enables meeting participants to participate in an online meeting without having to replace the terminal hardware by analyzing the reasons for failure of the multimedia session, and thereby correcting or supplementing those reasons.

The third aspect of the present invention is made in consideration of the technical situation as described above, and the technical task is to implement a new max-forward setting method and system for SIP protocol using artificial intelligence to improve the SIP protocol, which can be said to be one of the de facto Internet standards for teleconference.

In order to solve all or part of the above technical problems, the first aspect of the present invention proposes a way to further enhance the security level of the meeting contents through three core configurations: a media server, a security DB, and an AI security module that can support AI security, based on the technical requirements for meeting security in the above-mentioned conventional technology.

That is, according to the present invention, in a method implemented by a computer executing meeting contents security by AI in a multimedia session established between two or more meeting participant devices, one of the meeting participant devices, i.e., the first participant device, receives the multimedia contents packet requested by one of the meeting participant devices, i.e., the second participant device, through the network; the secure media server stores the received multimedia contents packet in a security DB and awaits the result of the security check by the AI security module before transmitting and processing the received multimedia contents packet in accordance with the transmission request; the AI security module is a step in determining whether the multimedia contents packet exceeds the security risk threshold based on one or more security policies; and the media security server is proposed a meeting security method by AI, wherein it includes a step of rejecting the transmission request for multimedia contents packets determined by the AI security module to exceed the security risk threshold, and replying to the failure response to the transmission request to the first participant's device in real time.

The first participant device and the second participant device may be connected to the network in a peer-to-peer (P2P) manner, and the secure media server may be a TURN (Traversal Using Relays around NAT) server running the Interactive Connectivity Establishment (ICE) framework.

Further, the establishment of the multimedia session between the first participant device and the second participant device is characterized by being handled by a signaling server according to the first aspect of the present invention.

In addition, the two or more meeting participant devices, that is, meeting devices, are characterized by using the secure media server as a central server responsible for transmitting and receiving the multimedia contents packets between the two or more meeting participant devices by means of a cloud network environment.

On the other hand, after the determination of whether the security risk threshold has been exceeded by the AI security module, the security method of the conference by AI is proposed, which is characterized by summarizing whether the judgment by the AI security module is consistent with the actual results, or real-world judgment done separately from the AI by a security administrator, of the security check on the multimedia contents packet by a confusion matrix, and further by including a step of optimizing and adjusting the security risk threshold by the Geometric Mean (G-Mean) technique applied to the imbalanced classification.

The first aspect of the present invention is possible to be implemented as a meeting security system by AI. That is, according to the present invention, in a server system executing meeting contents security by AI in a multimedia session established between two or more meeting participant devices, one of the meeting participant devices, i.e., the first participant device, receives the requested multimedia contents packet sent over the network to the other of the meeting participant devices, i.e., the second participant device; a security DB stores packets of the multimedia content received from the secure media server and restricting external access; and an AI security module determines whether the multimedia contents packets stored in the security database exceed the security risk threshold based on one or more security policies and executing a security check, and the media security server is proposed for a meeting security system by AI characterized by executing the transmission request only for the multimedia contents packets determined not to exceed the security risk threshold.

In the meeting security system of the present invention, a meeting security system by AI is proposed where the first participant device and the second participant device are connected to the network in a peer-to-peer manner, and the secure media server is a TURN server running the ICE framework.

For the meeting security system of the present invention, it is characterized by further introducing a signaling server that assists in establishing the multimedia session between the first participant device and the second participant device.

For the meeting security system of the present invention, the two or more meeting participant devices are characterized by using the secure media server as a central server responsible for transmitting and receiving the multimedia contents packets between the two or more meeting participant devices by a cloud network environment.

According to the meeting security system of the present invention, after the determination of whether the security risk threshold is exceeded by the AI security module is completed, the AI security module is implemented such that the AI security module in a meeting security system creates a confusion matrix regarding whether the judgment by the AI security module is consistent with the actual results of the security check on the multimedia contents packet, and automatically optimizes and adjusts the security risk threshold by the G-Mean technique applied to the imbalance class.

Next, the second aspect of the present invention relates to a method for using the Session Description Protocol (SDP) to establish a multimedia session between at least two terminals, including a first terminal and a second terminal.

Specifically, in the first step the first terminal transmits a first SDP message consisting of the first session description information about the first terminal to the second terminal in order to use a prescribed application layer protocol when connecting a session with the second terminal; in the second step the first terminal receives a session establishment failure message from the second terminal stating that at least one of the first session description information contained in the first SDP message cannot be accepted by the second terminal; and in the third step an SDP failure compensation method using AI is proposed, wherein the first terminal generates a second SDP message containing the second session description information and transmits it to the second terminal based on the reason for the session failure contained in the session establishment failure message. That is, the first terminal generates a second SDP message containing the second session description information supplemented by an AI SDP application embedded in the first terminal and transmits it to the second terminal.

In another second aspect of the present invention, when a Session Description Protocol (SDP) is used to establish a multimedia session between at least two terminals comprising a first terminal and a second terminal, at the first step the first terminal transmits a first SDP message consisting of the first session description information pertaining to the first terminal to the second terminal for the purpose of using a predetermined application layer protocol when connecting a session with the second terminal; at the second step, the second terminal replies to the first terminal with a session failure message based on a fact that at least one of the first session description information contained in the first SDP message cannot be accepted by the second terminal; and at the third step, a method of completing SDP failures using AI is proposed wherein the second AI SDP application installed on the second terminal generates a second SDP message containing a second session description information supplementing one or more items corresponding to the reason for the session failure corresponding to the first session description information based on the reason for the session failure replied in the above-mentioned second step, and transmits the generated second SDP message from the second terminal to the first terminal.

In the SDP failure compensation method using AI according to the second aspect of the present invention, if the item corresponding to the reason for the session failure is a media type, the complementation is characterized by a process of generating a media type required for session connection by a generative AI tool included in the first or second AI SDP application.

In the method of resolving SDP failures using AI according to the second aspect of the present invention, if the item corresponding to the reason for the failure of the session is a media format, the above-mentioned supplementation is characterized by a process in which the first or second AI SDP application automatically installs a codec supporting the media format corresponding to the reason for the session failure on the first terminal or the second terminal.

In the SDP failure compensation method using AI according to the second aspect of the present invention, if the item corresponding to the reason for the session failure is a syntax error (that is, malformed syntax) of the SDP message, the supplement process is characterized by a process of syntax correction by a machine learning tool and a generative AI tool included in the first AI SDP application in accordance with the syntax writing (or construction) rules predetermined by the SDP.

On the other hand, the second aspect of the present invention can be implemented as a system using SDP (Session Description Protocol) to establish a multimedia session between two or more terminals. i.e., a first terminal equipped with a first AI SDP application; and a second terminal capable of networking with the first terminal and equipped with a second AI SDP application. More specifically, in the first step, the first AI SDP application transmits a first SDP message consisting of the first session description information about the first terminal to the second terminal in order to use a predetermined application layer protocol when connecting to the second terminal; in the second step, the second terminal transmits a reply for a session establishment failure message stating that at least one of the first session description information contained in the first SDP message cannot be accepted by the second terminal; and in the third step a second SDP message is generated by AI containing a second session description information automatically supplemented with one or more items corresponding to the session failure reason among the first session description information on the basis of the session failure reason contained in the session establishment failure message and the second SDP message is transmitted it to the second terminal wherein an AI-based SDP failure compensation system is proposed, characterized by executing the fourth step repeating the third step until the multimedia session is established between the first terminal and the second terminal.

The SDP failure compensation system of the present invention relates to a system according to a second embodiment that uses a Session Description Protocol (SDP) to establish a multimedia session between two or more terminals including a first terminal equipped with a first AI SDP application and a second terminal that can be connected to the first terminal and is equipped with a second AI SDP application. In more detail, the first AI SDP application in the system transmits a first SDP message consisting of the first session description information about the first terminal to the second terminal in order to use a predetermined application layer protocol when connecting with the second terminal. Then the second AI SDP application sends to the first terminal a message with a session establishment failure message that at least one of the first session description information contained in the first SDP message cannot be accepted by the second terminal. The second AI SDP application now generates a second SDP message containing a second session description information supplemented with one or more items corresponding to the reason for the session failure among the first session description information based on the replied session failure reason, and transmits it from the second terminal to the first terminal. Here, an AI-based SDP failure compensation system is proposed, wherein the second AI SDP application repeats the steps of transmitting the new transmission between the first terminal and the second terminal until the multimedia session is established.

In the SDP failure complementing system of the present invention, if the item corresponding to the reason for the session failure is a media type, the complementation is characterized by a process of generating a media type required for session connection by a generative AI tool included in the first or second AI SDP application.

In the SDP failure complementing system of the present invention, if the item corresponding to the reason for the session failure is a media format, the supplementation is characterized by a process in which the first or second AI SDP application automatically installs a codec supporting the media format corresponding to the reason for the session failure on the first terminal or the second terminal on the first terminal or the second terminal.

In the SDP failure complementing system of the present invention, if the item corresponding to the reason for the session failure is a syntax error (malformed syntax) of the SDP message, the complement is characterized by a process of syntax correction by a machine learning tool and a generative AI tool included in the first SDP application in accordance with the syntax writing rules predetermined by the SDP protocol.

Finally, the third aspect of the present invention relates to a method of executing an SIP (Session Initiation Protocol) for the establishment of a multimedia session for at least one transmitting (that is, sender) terminal and one receiving (that is, receiver) terminal.

Specifically, the AI SIP application installed on the sender terminal periodically tracks the number of hops required to transmit IPv4 or IPv6 packets from the receiver terminal to the sender terminal; the AI SIP application obtains the average value of the interval in a predetermined period unit for the number of hops tracked periodically. Then the AI SIP application sets the predetermined natural number to add or subtract a predetermined natural number from the mean value of the interval when executing the SIP protocol by the sender terminal, and continues the periodic tracking. The AI SIP application counts the number of times in which the AI max-forward parameter value turned out to be insufficient during the periodic tracking, and an AI-based max-forward setting method is proposed, wherein the AI SIP application includes a step of adjusting the AI max-forward parameter value by increasing the value of the AI max-forward parameter by a predetermined incremental value, when the number of the counted recalls reaches the threshold.

For the AI-based max-forward setting method according to the present invention, the AI SIP application is characterized by further completing a step of adjusting the AI max-forward parameter value by reducing the value of the AI max-forward parameter by a predetermined decremental value, provided that the AI SIP application has not reached the threshold during a certain period of time during which the periodic tracking is executed.

In the case of the AI-based max-forward setting method according to the third aspect of the present invention, if the adjustment step of increasing or decreasing the AI max-forward parameter value is frequently performed in excess of the predetermined standard or criteria, the predetermined incremental value or the predetermined decremental value may be substituted for the adjusted incremental value or the adjusted decremental value.

In the case of an AI-based max-forward setting method according to the third aspect of the present invention, if the adjustment step of increasing or decreasing the AI max-forward parameter value is frequently performed in excess of a predetermined standard, the frequency of the periodic tracking may be adjusted.

In the case of an AI-based max-forward setting method according to the present invention, the AI SIP application is characterized by displaying the fact that the “max-forward” parameter value used in the SIP protocol is now the “AI max-forward” parameter value as a new or replaced field value of at least one of the headers of the IPv4 packet, the header of the IPv6 packet, or the SIP message header.

On the other hand, the third aspect of the present invention may be implemented as a network system running the SIP (Session Initiation Protocol) for the establishment of a multimedia session between two or more terminals. Specifically, a sender terminal transmitting an INVITE message pursuant to the SIP protocol, and a receiver terminal responds to the INVITE message in accordance with the SIP protocol, wherein the sender terminal is equipped with an AI SIP application, and the AI SIP application periodically tracks the number of hops required to transmit IPv4 or IPv6 packets from the receiver terminal to the sender terminal. Furthermore, the mean value over the interval is obtained in a predetermined unit period (for example, monthly, yearly, etc.) for the number of hops that are periodically tracked. Here, some adjustment process may be required by subtracting a predetermined natural number from the mean value of the interval when executing the SIP protocol by the sending terminal. Then, the sender terminal uses the AI max-forward parameter value, and continues the periodic tracking. When counting the number of times in which the AI max-forward parameter value is insufficient during the periodic tracking, if the number of the counted recalls reaches a threshold, an AI-based max-forward setting system is proposed, characterized by executing a step of adjusting the AI max-forward parameter value by increasing it by a predetermined incremental value.

For the system according to the third aspect of the present invention, the AI SIP application is characterized by further executing a step of adjusting the AI max-forward parameter value by reducing the value of the AI max-forward parameter by a predetermined decremental value, provided that the number of the counted recalls has not reached the threshold during a certain period of time during which the periodic tracking is executed.

In the case of an AI-based max-forward setting system according to the third aspect of the present invention, the AI SIP application is characterized by substituting the predetermined incremental value or the predetermined decremental value with an adjusted incremental value or an adjusted decremental value when the adjustment step of increasing or decreasing the AI max-forward parameter value is too frequently carried out in excess of the predetermined criteria. Such criteria may be set as 1, so that only a single occasion of AI max-forward failure would trigger the adjustment process described above.

In the case of an AI-based max-forward setting system according to the present invention, the AI SIP application is characterized by adjusting the frequency of the periodic tracking when the adjustment step of increasing or decreasing the AI max-forward parameter value is frequently performed in excess (that is, excessive occasion) of the prescribed standard or criteria. Sometimes, it might be preferable to consider whether the prescribed standard or criteria should be adjusted. For example, if the criteria had been set three occasions per week, and if the administrator believes that this standard is too strict or vice versa, then the AI may consider what level of frequency criteria would be appropriate for determining the excessive occasions.

For an AI-based max-forward setting system according to the third aspect of the present invention, the AI SIP application is characterized by displaying that the max-forward parameter value used in the SIP protocol is currently the AI max-forward parameter value as a field value of at least one of the headers of the IPv4 packet, the header of the IPv6 packet, or the SIP message header.

The first aspect of the present invention is applicable regardless of whether the meeting is an online meeting or an offline meeting. The meeting participants use the participant's device to access the network and share the meeting contents by the device, and thus the present invention focuses on the fact that the shared meeting contents will be transmitted and received as multimedia data packets such as audio or video for both of online meeting and offline meeting.

In other words, in the case of the present invention, the media server passing through the transit media server stores all the meeting contents in a security DB in real time before the meeting contents are sent and received between the meeting participants, and the AI security module analyzes in real time whether there is a possibility of violation of the security policy for each stored meeting content according to a prescribed algorithm. And when the AI security module's analysis determines that the risk of a security breach exceeds the threshold, the media server is required to prevent the media server from sharing the meeting content with the risk of a security breach to the other party at all.

Instead of an approach in which the meeting contents is shared among the meeting participants after it is shared among the meeting participants, the AI security module according to the first aspect of the present invention analyzes the security risk in real time during the meeting process in regard to the meeting participants and determines in real time whether the meeting contents are of a good nature to be shared. Of course, in order for such an AI security module to operate properly according to the purpose of the present invention, where and when to run the AI security module is a very important issue, and in the case of the present invention, the media server is in charge of transmitting and receiving multimedia meeting contents between meeting participants and cooperates with the AI security module for security. The security DB is prepared to ensure that the multimedia data is not shared or lost to other places during the security check by the AI security module for the meeting contents.

Furthermore, the present invention proposes an AI meeting security technology that can be commonly applied in various meeting environments that enable multi-party multimedia conferences, such as SIP, H.323, and WebRTC, and thus the first aspect of the present invention is less dependent on specific standard technologies or network protocols.

In addition, the access rights to the materials or contents stored in the security database can be set for each meeting or based on the circumstances of the company or individual to which the present invention intends to apply. For example, the meeting contents that does not pose a security risk as a result of the security inspection of the AI security module according to the present invention may be set to be automatically deleted from the security database after being sent to the other party, but if a security risk is found, such meeting contents may be permanently stored in a security DB and, for example, only executives and specific employees of a certain rank or above or individuals who know a specific access password would be able to access the security database later.

Finally, the concept of conference or meeting in the present invention is not bound by the name, subject matter, agenda, or title of the conference or meeting as long as it involves a multi-party communication. If the present invention is used to protect privacy or trade secrets, it can be implemented not only for the company but also for the individual or daily conversations between friends.

On the other hand, the second aspect of the present invention is that if a multimedia session is not established due to the failure of SDP negotiations, an AI SDP application intervenes to analyze the cause of the session failure, and automatically generates an SDP syntax using a generative AI tool based on the results of the analysis, and attempts to connect the session with a new SDP message.

The reason for the failure of the SDP session can be trained by the AI. It is not only possible to learn from international standard documents such as RFC-3551 and RFC-3261, but it may also be desirable to obtain a large number of cases from the actual online meeting environment as an AI training dataset to train the AI software according to the present invention with the data, and combine the training result to the generative AI tool to generate an appropriate SDP syntax to fix the session failure.

The cause of SDP failure may be non-negotiable. However, in many cases, SDP negotiation failure is caused by several facts including (i) that SDP messages violated the rules of syntax creation, (ii) that media types or media formats are not supported by either of meeting participant terminals, or (iii) that audio or video codecs are not installed on either terminal. Maybe sometimes the uninstalled codec is set as the SDP priority negotiation target. There are cases where negotiation is possible. In other words, the most important feature of the present invention is that it is possible for an AI SDP artificial intelligence application (AI App) pursuant to the second aspect of the present invention to intervene and attempt to negotiate a new SDP message within the scope of not violating the SDP standard regulations that do not encourage repeated and excessive INVITE attempts by the SIP UA (that is, user agent).

If an accurate diagnosis of SDP failure by AI and subsequent SDP modification are made according to the present invention, it can be expected that the number of cases in which a multimedia session cannot be established due to the failure of SDP negotiation can be reduced to at least some extent. Since this is a process that has nothing to do with increasing the network load due to the repetition of excessive session connection attempts, it is expected that the advantages such as the convenience of session connection that can be obtained by the present invention will be more highlighted than the network burden caused by SDP supplementation.

The third aspect of the present invention proposes to introduce artificial intelligence technology to deviate from the convention of setting the max-forward parameter to 70 in the existing SIP protocol. The max-forward parameter limits the number of hops that can be passed through a SIP message transmission, but the invention judges that 70, which is currently set as a default, is too much.

A large number of hops that can pass through is not necessarily undesirable, because if the number of hops that can pass through is set, it means that some packets are less likely to be dropped on the network path, and there will be more attempts to find a routing route to the destination.

However, if the number of hops is set high, the packets may stay on the network for a longer time, which may mean that the packets may be manipulated by a third party such as a hacker. Therefore, a higher number of hops than necessary may not be desirable for network security.

In addition, for example, in a network environment where SIP sessions are difficult to establish, the default value of 70 above means that SIP messages continue to try to find route routes 70 times on the network. Thus, if the network environment is unstable, a large max-forward default value can put a burden on network resources.

The present invention proposes a method for having an artificial intelligence set the max-forward parameter in the SIP protocol, and if the max-forward parameter is set by the artificial intelligence as necessary, to display the fact somewhere in the SIP header. Furthermore, since the SIP standard supports both IPv4 or IPv6 Internet protocols, the present invention proposes a method to allow the header fields related to TTL (Time To Live) or Hop Limit in the header of IPv4 or IPv6 packets to be assigned appropriate values by artificial intelligence by adjusting the SIP-related max-forward parameters.

In particular, the present invention assumes that the network transmitting SIP messages is an IPv4 or IPv6 network, wherein the number of hops required to transmit IPv4 or IPv6 packets between the transmitting and receiver terminals is periodically tracked, and the mean value over the interval is obtained for the number of tracked hops in a predetermined period unit (e.g., the mean over the interval may be obtain on a monthly basis, then one month will be the period unit or unit period), and then the AI SIP application installed on the sender terminal determines the so-called “AI max-forward” parameter by adding or subtracting a predetermined natural number from the mean value of the interval.

Furthermore, by continuing to track the IP routing route periodically even after setting the AI max-forward parameter, if the AI max-forward parameter value exceeds the threshold of a certain number of times, it is proposed to increase the AI max-forward parameter value by a certain incremental value. Obviously, the invention does not want the max-forward value to be too small.

Conversely, if the AI SIP application has not reached the above threshold for a certain period of time to perform periodic tracking, it suggests that the current AI max-forward parameter value is sufficient or too much and thus further suggest adjusting the current AI max-forward parameter value by reducing the parameter value by a predetermined decremental value.

Through the above configuration, it is possible to calculate AI max-forward parameters optimized for each network, and it is expected to improve the security of SIP while efficiently using network resources at a time like today as online meetings are becoming very common.

### BRIEF DESCRIPTION OF THE DRAWINGS

The present invention may be better understood with reference to the following drawings and descriptions. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a drawing for describing an exemplary network structure to establish a multimedia session between two or more meeting participants so that the meeting security technology according to the present invention can be applied. For reference, the multimedia session according to FIG. 1 between two or more meeting participants may be established by SIP (Session Initiation Protocol), which is a representative application layer protocol to which the SDP technology is complementary so that the second and third aspect of the present invention may be relevant to FIG. 1.

FIG. 2A and FIG. 2B are drawings to illustrate two exemplary ways in which Session Description Protocol (SDP) information is exchanged before a multimedia session is established between two or more meeting participants.

FIG. 3 is a drawing representing an AI meeting security system according to the first aspect of the present invention.

FIG. 4 is an illustrative drawing of an offline meeting system (or conference room) to which an AI meeting security system can be applied according to the first aspect of the present invention.

FIG. 5A and FIG. 5B are drawings for illustrating the principles of the AI meeting security system according to the first aspect of the present invention that can be realized in both the cloud-based central server system and the peer-to-peer connection system, respectively.

FIG. 6 is a drawing representing the first aspect of the present invention in which AI meeting security is applied between two or more meeting participant devices while a multimedia session is established in a peer-to-peer manner.

FIG. 7 is a drawing for illustratively showing the packet structure of a multimedia contents that may be subject to an AI meeting security inspection according to the first aspect of the present invention.

FIG. 8 is an illustrative drawing showing the overall configuration of AI software that can be adopted to implement the security inspection function of the AI security module, the SDP failure resolution function, or the SIP supplementing function according to the present invention in general.

FIG. 9 is a flowchart representing an illustrative algorithm for executing the security improvement of meeting contents in an AI meeting security system according to the first aspect of the present invention.

FIG. 10 is a drawing to illustrate a method for compensating for SDP failures using AI based on the first embodiment of the second aspect according to the present invention.

FIG. 11 is a drawing to illustrate a method for compensating for SDP failures using AI based on the second embodiment of the second aspect according to the present invention.

FIG. 12 is an illustrative flowchart comprehensively representing an SDP failure compensation algorithm using AI based on the first and second embodiments according to the second aspect of the present invention.

FIG. 13A is a drawing representing the IPv4 (Internet Protocol Version 4) packet structure of an IP network that can be used for SIP packet transmission with respect to the adjustment of the number of hops according to the third aspect of the present invention.

FIG. 13B is a drawing representing the internet Protocol Version 6 (IPv6) packet structure of an IP network that can be used in SIP packet transmission with respect to the adjustment of the number of hops according to the third aspect of the present invention.

FIG. 14A is a drawing that illustrates the results of an exemplary search for the routing path of an IPv4 packet according to the third aspect of the present invention.

FIG. 14B shows the results of an exemplary search for the routing path of an IPv6 packet according to the third aspect of the present invention.

FIG. 15 is an illustrative drawing showing a message structure including the SIP header in which the number of hops can be adjusted according to the third aspect of the present invention.

FIG. 16 is a drawing illustratively representing an IP-based SIP network to illustrate the way in which the number of hops is adjusted by AI according to the third aspect of the present invention.

FIG. 17A and FIG. 17B are graphs that illustrate the results of periodic measurement of the number of hops required by the sender terminal to transmit packets to the destination in order to adjust the number of hops by AI according to the third aspect of the present invention.

FIG. 18 is a flowchart representing an AI-based max-forward setting algorithm for upgrading max-forward parameters for the improvement of the SIP standard protocol in an IP network according to the third aspect of the present invention.

### DETAILED DESCRIPTION

Various aspects of the present invention will be explained in detail by referring to the attached drawings below.

### First Aspect of the Present Invention

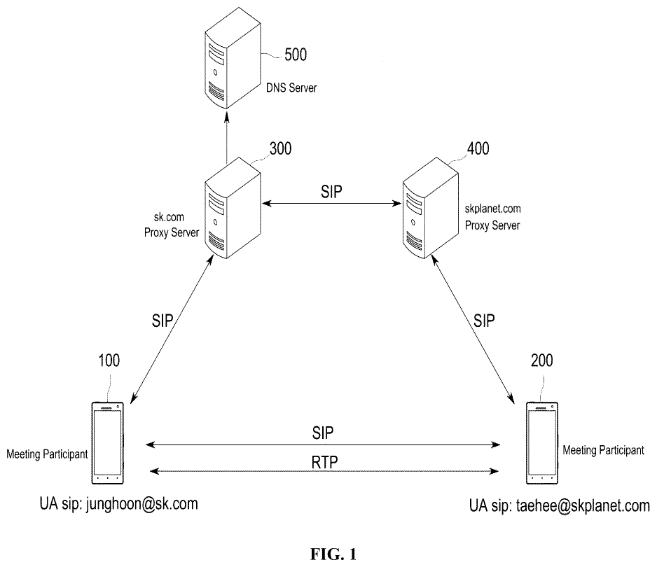

FIG. 1 is a drawing for describing an exemplary network structure to establish a multimedia session between two or more meeting participants 100, 200 so that the meeting security technology according to the present invention can be applied.

For reference, the multimedia session according to FIG. 1 between two or more meeting participants may be established by SIP (Session Initiation Protocol), which is a representative application layer protocol to which the SDP technology is complementary so that the second and third aspect of the present invention may be relevant to FIG. 1.

Referring to FIG. 1, the meeting security method and system by AI according to the first aspect of the present invention are applicable, for example, to a conference in which a multimedia session is established according to the SIP (Session Initiation Protocol) standard although a protocol or network technology other than SIP may be applied to establish a multimedia session.

For reference, the SIP in FIG. 1 is defined in the RFC-3261 document published in June 2002 by the International Internet Engineering Task Force (IETF). In this Specification, SIP is sometimes referred to as the SIP protocol (although SIP itself is a protocol) or, for convenience, the SIP standard. In addition, since the present invention assumes that the meeting participants (e.g., 100 and 200 in FIG. 1) use IT devices such as smartphones, laptops, and PCs to conduct the conference while connected to the network. The reference numbers shown in the drawings regarding the meeting participants can sometimes refer to the participants themselves who participate in the meeting as a sender or receiver, but at the same time, it refers to the participant's “meeting device” used by the participants such as smartphones.

The SIP is a text-based protocol that consists of strings in the Unicode Transformation Format-8 (UTF-8) format. According to RFC-3261, a “conference” in the SIP protocol is defined as a multimedia session that includes multiple participants, which would be the same meaning of “meeting” in the present invention. “Multimedia Conference” defined in SIP is a sub-concept of “Multimedia Session,” in which there is a Sender and a Receiver who exchange multimedia data such as audio or video, and there is a series of data streams from the sender to the receiver. RFC-3261 states that SIP sessions can be audio, video, or game. As will be discussed later, the SIP standard stipulates that a successful SIP message reply, such as “200 OK” message, will be created between the sender and receiver for an INVITE request from the sender.

Referring to FIG. 1 again, multiple meeting participants 100, 200, including the sender 100 and receiver 200, correspond to User Agent (UA; 100, 200) in the SIP protocol. UA is defined in SIP as a logical configuration (Entity) that can play the role of both a User Agent Client (UAC) and a User Agent Server (UAS), which is understandable given that the sender of SIP-related requests (Request; any message sent from the client to the server for the purpose of performing a specific action) is the UAC and the UAS is the one who responds to such requests, but the role of the sender or receiver cannot continue to be the same during the whole meeting. In other words, even if a specific UA sends a request to someone as a UAC now, at the same time or in a different time zone, the same UA may act as a UAS that responds to other people's requests. In addition, when UAC sends a request signal to UAS, it expects a server-side response, and thus all messages sent and received between UAC and UAS, including this request signal, may be referred to as SIP Transactions in a server-client network system. For this reason, the SIP mentions that both UAC and UAS can be defined as a Transaction User (TU), with some exceptions. Note that on a “transactional” basis, for example, a specific SIP Phone, or “meeting device in the present invention,” can act as a UAC, and then in the next transaction it can act as a UAS that generates a response signal for requests from other meeting participants. As such, the UAC and UAS concepts are not absolute, but are relatively determined for each SIP transaction unit.

On the other hand, the SIP telephone used by the sender 100 or receiver 200 in FIG. 1 includes a hard phone and a softphone, and all of the “meeting participant's device; User Device” can also be either a hard phone or a soft phone. Thus, the “meeting device” in the present invention may include a hard phone or a soft phone. A hard phone usually refers to a conference phone that is wired using an Ethernet cable, but there are also wireless hard phones. A softphone is an application (application, or “app”) that can connect two or more meeting devices to perform phone functions, and such applications are mainly installed in various IT devices such as desktop PCs, laptops, smartphones, and smart pads. Conversely, IT devices such as conference room telephones, wireless hard phones, PCs, laptops, smartphones, and smart pads can all fall under the definition of participant's devices, or “meeting device,” under the present invention in general. In addition, in the present invention, for example, “sender 100”, “receiver 200” or “conference participant X” actually refers to the “participant meeting device” such as SIP telephone or smartphone used by the meeting participants. However, for the convenience of explanation, the term “participant device” may be replaced by other expressions such as “sender 100” and “receiver 200” interchangeably. In the same vein, if a meeting participant uses more than one participant's device, for the convenience of description, only one of the multiple participants' devices (e.g., if they are using a smartphone and a smart pad at the same time) shall be referred to as the meeting device of that participant.

Note that SIP signals, especially REQUEST signals, must include a header field called Via. Here, Via refers to the other party's IP address (Internet Protocol Address) when the sender 100 sends a request and expects a reply from the other party.

In other words, Via is metadata that specifies the location of the recipient and indicates the transfer method used for the transaction. The SIP scheme supports both Internet Protocol version 4 (IPv4) and Internet Protocol version 6 (IPv6), thus an Internet address such as “skll.skplanet.com” can be Via. More specifically, Via is written as a syntax that specifies the name of the protocol, the version of the protocol, the mode of transmission, the IP address of the UAC, and the protocol port (such as 5060) used to send any request. For example, “Via: SIP/2.0/UDP ski1.skplanet.com; branch=z8hG5bK889abcdefg” may be an example of Via syntax. In this example, the value of the parameter Branch should have a unique value for all requests sent by UA based on time and place. SIP is currently known to be up to version 2.0. UDP (User Datagram Protocol) is one of the internet protocols used for sending messages.

However, in the example of FIG. 1, Via alone may not be enough to identify the recipient, or receiver, 200 or the meeting device used by the receiver 200. Therefore, the header field called To is also used in SIP. The Uniform Resource Identifier (URI) used by SIP is called the “SIP URI”, and as shown in FIG. 1, the sender 100 can specify the conference party (200, i.e., the recipient or the receiver) by specifying the “To” header field in the same way as “sip:taehee@skplanet.com”, for example. In this example, “taehee” is the name of the SIP user (User, 200), and unlike shown in FIG. 1, the mobile phone number itself can be the user name of SIP, for example.

The sender 100 in FIG. 1 is identified by a mandatory header field called From, and similar to the case of the receiver 200, the sender 100 can be identified in the form of “sip:junghoon@sk.com”, etc. In the case of SIP, an arbitrary string may be added to the SIP URI of the sender 100 and used in the future identification process.

In FIG. 1, the sk.com server 300 that manages the domain of the sender 100 will act as a proxy server, for example, when a sender named junghoon@sk.com 100 wants to send a message called INVITE to initiate a conference multimedia session with a receiver named taehee@skplanet.com 200. The sk.com proxy server 300 is responsible for sending the INVITE message on behalf of the sender 100. Of course, the proxy server 300 also plays the role of forwarding a reply sent to the sender 100 on the SIP network to the sender 100.

After the sender 100 sends the INVITE message, the proxy server “sk.com” 300 in FIG. 1 will attempt to find the location of the proxy server 400, which manages the domain on the recipient 200 side, for example, through the location search function using the DNS (Domain Name Service) server 500. If skplanet.com succeeds in locating the proxy server 400, the sk.com proxy server 300 on the sender side of the sender 100 sends the INVITE message indicating the sender 100 wants to send to the IP address of the skplanet.com proxy server 400. If the INVITE message is successfully sent, the skplanet.com proxy server 400 sends a first reply to the sk.com proxy server 300 in the form of “100 OK”, for example, to notify that the proxy server 400 has well received the INVITE message and is currently processing it.

After the “100 OK” reply is made, the recipient's (e.g., 200, taehee@skplanet.com) SIP phone, 200, e.g., smartphone, etc., rings the answer tone. Here, if the recipient 200 accepts the conference request, the recipient's SIP phone 200 sends a reply in the form of “200 OK” to inform the recipient 200 that it has responded to the sender's 100 INVITE request. If the recipient 200 does not want to talk with the sender 100, an “Error” message will be replied by the recipient 200. In addition, if the recipient 200 disconnects from the conference at some point after responding to the INVITE request, the SIP phone 200 of the recipient 200 will generate a BYE message and send it to the sender 100.

To make it easier to understand FIG. 1, the SIP phone, 100, e.g., smartphone, etc., used by the sender 100, junghoon@sk.com, continues to make a phone connection sound until the above “200 OK” message is received, informing or alerting the sender 100 that the phone/conference connection has not yet been made. If the sender 100 receives the above “200 OK” message, the SIP phone 100 of the sender 100 will no longer produce a call tone and will send an Acknowledgement or “ACK” Message to the SIP phone of the recipient 200. In this example, the sk.com proxy server 300 and the skplanet.com proxy server 400 have already succeeded in connecting the sender 100 and the receiver 200, and thus the above “ACK” message can be sent directly from the sender phone 100 to the receiver phone 200 without going through the proxies 300, 400 anymore. For reference, if the recipient 200 sends a “200 OK” message to the sender 100 but does not receive an ACK message within a certain period of time, the recipient 200 sends a BYE message to terminate the session.

As mentioned above, in the case of SIP standard, when a reply in the form of “200 OK” is received by the sender 100, a peer-to-peer relationship called Dialog according to SIP regulation is formed between the sender 100 and the receiver 200, and a session is formed between the sender 100 and the receiver 200 to directly transmit and receive multimedia meeting contents without going through any intermediary agency like proxies. SIP sessions can include multimedia conversation channels such as RTP (Real-time Transport Protocol).

For reference, in the example of FIG. 1, in order for the skplanet.com proxy server 400 to recognize the participant's device 200 corresponding to the recipient taehee@skplanet.com, a user with the user name “taehee” must go through the process of registering with the skplanet.com proxy server 400 in advance. This process is done by the SIP phone 200 of the user named “taehee” 200 sending a SIP transaction message requesting REGISTER, that is, registration, to the proxy server 400 skplanet.com which must associate the SIP URI and device usage information of the user 200 named “sip:taehee@skplanet.com” with the REGISTER request signal sent by himself or herself. In other words, the user “taehee” 200 informs his or her proxy server 400 of the meeting device (e.g., SIP phone, laptop, smartphone, VoIP phone of a video conferencing system, etc.) that is currently used for logging in, and the proxy server 400 registers the user information linked to the above REGISTER signal so that the skplanet.com proxy server 400 can know the location of the user, 200, taehee@skplanet.com, when it needs to process SIP-related signals in the future. This kind of SIP function that allows the skplanet.com proxy server 400 to properly find the recipient 200 in a future meeting through a procedure called registration is known as the Location Service, and the skplanet.com server 400 in charge of user registration may become both a proxy and a registrar. The SIP protocol's location discovery service also includes a so-called redirect function, in which the proxy server 400 fails to find the recipient 200 and retries the connection using the contact information of another recipient.

In FIG. 1, there were two proxy servers 200 and 400, skplanet.com and sk.com, but if the conference users have different domains and the distance of the teleconference is far, it may be necessary to route several or dozens of hop proxies (not shown in FIG. 1). If the number of hops is set too much, it can put a burden on network operations, and conversely, if the number of hops is too small, there is a risk that the INVITE message will be handled as an error on some path in the middle before the meeting is established. The configuration called Core included in the UA is responsible for selecting the next hop so that the proxy servers 200, 400 may designate the next hop after them. In other words, in the example in FIG. 1, the core configuration contained in the proxy servers 200, 400 set the routing path. Also, although not shown in FIG. 1, if there are multiple users with identical name “taehee” in the same domain on the skplanet.com server 400 side during the registration stage, for example, the REQUEST-URI such as “INVITE to sip:taehee@skplanet.com” would be deemed to be ambiguous, and thus it may be finally processed by the skplanet.com server 400 with a “485” response which means that the server 400 will handle the registration request as an error.

Referring to FIG. 1 above, the process of establishing a multimedia session to which the present invention can be applied is examined. It is important to note that the SIP exemplified in FIG. 1 is the protocol used to initiate a session, and SIP itself is not involved in how the meeting is operated. That is, the SIP does not care about the floor control. Here, the floor refers to the temporary permission for the meeting given to multiple users 100 and 200 in FIG. 1 who cooperate with each other through meetings, etc., and through floor control, meeting participants 100, 200 can share meeting resources such as audio and video data or meeting contents with each other. However, since the present invention supports the SIP session connection process as shown in FIG. 1 and can also be implemented as a security tool to control the contents shared during the conference for security purposes, the fact that SIP is not involved in floor control itself does not constitute any restriction in the implementation of the first aspect of the present invention.

Similarly, it should be noted that conferencing standard technologies such as WebRTC or H.323 can be integrated with the meeting security system of the present invention. For reference, H.323 is one of the so-called “H” series standards related to audiovisual and multimedia systems among the standards of the Telecommunication Standardization Sector of ITU-T (ITU), and although it is a standard created by the International Telecommunication Union (ITU), there are similarities between H.323 and the SIP protocol to the extent that it is somewhat compatible with the IETF's RFC-3261. However, in the case of H.323, conference is defined in more various ways compared to SIP. For example, in H.323, a broadcast conference refers to a conference in which there are one sender and multiple recipients, but no two-way media stream is possible. In addition, if there are two meeting participants, it is called a point-to-point meeting in H.323. If there are three or more meeting participants, it is called a multipoint meeting in H.323. In H.323, there is a concept of an Endpoint corresponding to SIP UA, which defines an endpoint in case where three or more participant devices and gateways can be involved in a multipoint conference as a “multipoint control unit (MCU)”, but according to H.323, the MCU can also be applied to meetings between two people, and later the conference between two parties can be converted again into a multipoint conference with three or more participants. Other than this, there are various conference concepts defined in H.323, but further explanations about this will be omitted.

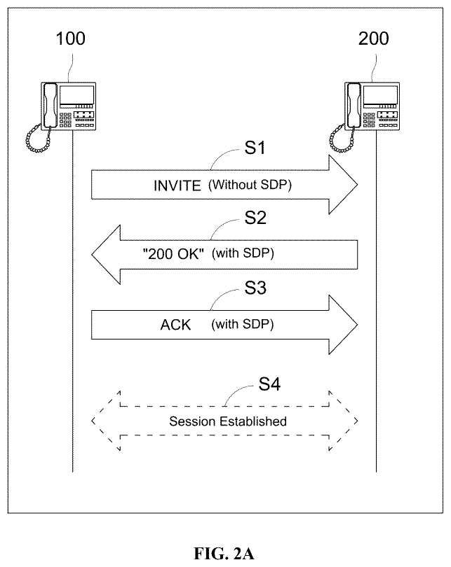

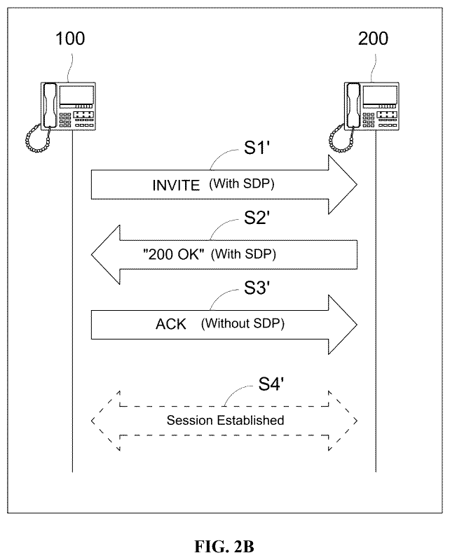

FIG. 2A and FIG. 2B are drawings to illustrate two exemplary ways in which Session Description Protocol (SDP) information is exchanged before a multimedia session is established between two or more meeting participants. The SDP is a protocol organized in the IETF's RFC-2327 document. SDP is a name used in SIP and non-SIP's, but the SDP concept is not much different from the session description technology for SIP or for other network technologies.

Although it is not mentioned in FIG. 1 when describing the SIP message and header fields, the SIP header fields contain some kind of session description encoded in the SDP format. In the example of FIG. 1, the sender 100 sends information about the media packet format supported by the sender's device 100 in SDP syntax via the INVITE message sent to the receiver 200, while the receiver 200 transmits the SDP information about the media packet format supported by the receiver's device 200 to the sender 100 when accepting the invitation. In this way, by exchanging information about the media types that can be supported by two UA devices 100 and 200 that the sender 100 and receiver 200 are currently using, an agreement or “handshake” may be achieved between the sender 100 and the receiver 200 on what to do with the characteristics of the multimedia session in this meeting.

Based on this understanding, if we first refer to FIG. 2A, FIG. 2A indicates that in step S1, the sender 100 sends an INVITE message to the receiver 200 and misses the SDP information for some reason. In step S2, the recipient 200 sends a message to approve the participation of the meeting with the “200 OK” message including the recipient's SDP information in it. At this point, in the case of FIG. 2A, the SDP information of the sender 100 side has not yet been transmitted to the receiver 200 in step S1. Therefore, the SDP information of the sender 100 side must be transmitted to the receiver 200 at the time of ACK transmission of step S3 before it is too late. Then, the multimedia session can be established in step S4. This is also called a delayed offer. In the case of SIP, it was mentioned earlier that the session can be audio, video, or game, but in fact, regardless of the session type of standard, it is natural that it would be difficult to establish a conference if a meeting device tries to connect to someone who is using another meeting device that does not support video files, for example. Therefore, it is necessary to exchange device performance information between devices participating in the meeting, such as whether the meeting device supports video or not, in the SDP format.

Referring to FIG. 2B, it can be seen that in the case of step S1, the sender 100 sent an INVITE message to the receiver 200 and included the SDP information on the sender 100 without omission at this time. In step S2′, the recipient 200 agrees to join the meeting with “200 OK” message, which contains the SDP information on the recipient 200 side, just like step S2. Since the SDP information of both the sender and receiver is exchanged, in step S3′ of FIG. 2B, the SDP information of the sender 100 need not to be included when sending an ACK message. A multimedia session will be formed between the sender 100 and the receiver in step S4′. In contrast to the delayed proposal method in FIG. 2A, the case in FIG. 2B is called Early Offer.

For reference, the SDP's method of exchanging and agreeing on information about the performance of the device between the sender 100 and the receiver 200, is also separately defined in the ITU-T H.245 standard. In H.245, the above “consensus” process is called “Negotiating Terminal Capacities,” but it can be seen as a similar standard created for a very similar purpose to the aforementioned SDP. In the case of WebRTC, which was mentioned earlier and will be described in detail later, it is configured to exchange SDP information between devices participating in the conference.

In FIG. 1 and in FIGS. 2A and 2B, the SIP is used as a representative example to illustrate how a multimedia session can be created between two meeting participants, but it should be emphasized again that any international standard or de facto conference standard technology, such as H.323 mentioned above or WebRTC, one of the representative open source projects for conferences, may be integrated with the first aspect of the present invention, and it may be preferable to be integrated as such. The present invention is a technology for security control of the contents of a meeting on the premise that a conference session is established, and if the establishment of a conference session and the security control of the meeting contents may be achieved at the same time, the overall system efficiency will increase and the user may have more convenient meeting experiences, by, e.g., the process of connecting the session and the multimedia transmission process without the need to run multiple independent applications or network equipment.

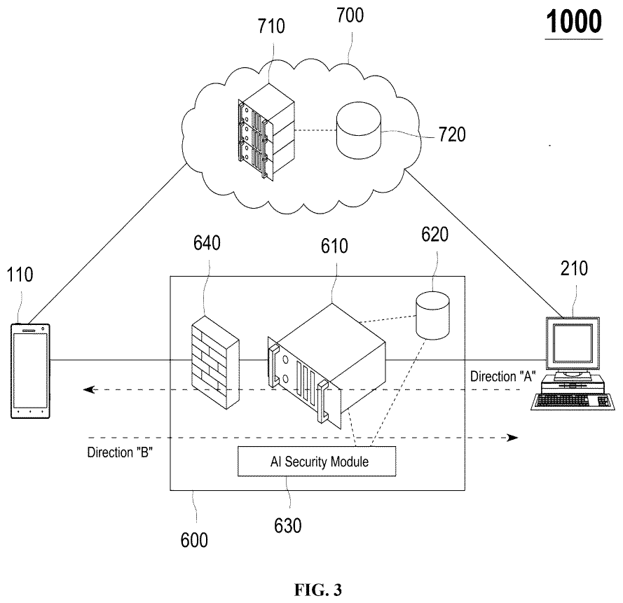

IG. 3 is a drawing representing an AI meeting security system 1000 according to the first aspect of the present invention. For reference, the devices used by the meeting participants 100, 200 in FIG. 3 may include UA such as SIP phones shown in FIG. 1, or H.323 endpoints, i.e., H.323 terminals, and other IT devices that support WebRTC, for example.

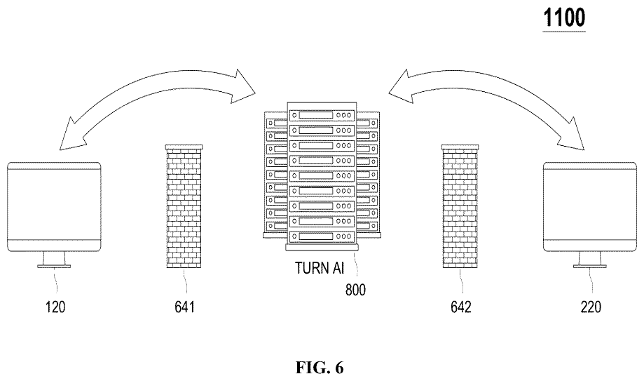

As shown in FIG. 3, an AI meeting security system 1000 according to the first embodiment of the present invention is applicable when a multimedia session is established by a signaling server 700 between two or more meeting participant devices 110 and 210. The signaling server 700 is a server that performs a function similar to the establishment of a conference session using the proxy servers 300, 400 described in FIG. 1. The signaling server 700 may include a cloud server device 710 and a cloud database 720 as exemplified in FIG. 3. The signaling server 700 will be additionally described later in FIG. 6.

In FIG. 3, the component directly responsible for the security of the meeting contents according to the present invention is the media server. The media server is a server responsible for transmitting and receiving multimedia content between meeting participants 110, 210, but in the case of the present invention, it is called an AI security media server system 600 considering that it is equipped with security functions by AI based on the present invention.

The AI security media server system 600 is located on the network path where multimedia transmission and reception between meeting participants 110, 210 take place, as shown in FIG. 3. In the case of the signaling server 700, it mainly sends and receives metadata for the establishment of the meeting between the meeting participants 110, 210, while the AI security media server system 600 is responsible for sending and receiving multimedia data packets, that is, meeting contents for security reasons.

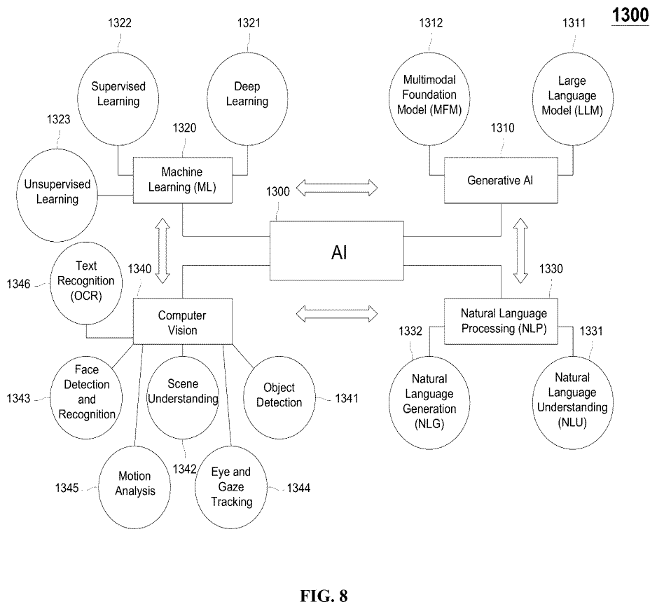

More specifically, the AI security media server system 600 includes a media server unit 610 and a security DB 620. In addition, it includes an AI security module 630 that executes various security-related operations by AI software (1300, see FIG. 8) in conjunction with the media server unit 610 and the security DB 620. The AI software 1300 is installed and executed on the AI security module 630, but if the AI security module 630 is integrated into the security database 620, the AI software 1300 may also be installed on the security database 620. For reference, the firewall 640 shown in FIG. 3 shows that the meeting participant 210 may be an employee of a company that uses a firewall to block, for example, malware. However, even if it is not a company, there may be many cases where a firewall 640 is installed on one or both sides of the participant's meeting devices 110, 210 to block malware.

The security DB 620 stores packets of multimedia contents that will be sent and received by the media server device 610. Depending on the security policy described below, external access to the security DB 620 may be severely restricted.

In the case of the AI security module 630 equipped with AI software (1300, see FIG. 8), the security check is performed by determining whether the security risk level of the multimedia contents packet stored in the security DB 620 exceeds the security risk threshold based on one or more security policies.

As previously discussed in FIG. 1, for example, in order to execute an online meeting, a multimedia session must be formed between two or more meeting participants 110, 210 according to standard technologies such as SIP or H.323. To this end, as shown in FIG. 3, for example, an external cloud server device 710 connected via the internet with the meeting participants 110 and 210 may support the formation of an RTP channel between the meeting participants 110 and 210, and in the case of the present invention, the AI security media server system 600 can perform the multimedia session connection operation performed by SIP, H.323 or WebRTC, etc. in an integrated manner. There is no need for separate proxy servers other than AI security media server system 600.

In FIG. 3, it can be observed that in the meeting security system 1000 by AI according to the first aspect of the present invention, for example, the multimedia contents (e.g., voice conversation contents, video streaming of video conference, text messages according during the meeting, slide presentation documents shared for the meeting, etc.) can be exchanged between a meeting participant belonging to a specific enterprise, e.g., 210, and a meeting participant outside the company, e.g., 110, through an AI security media server system 600. Therefore, the AI security media server system 600 can perform security risk checks on a contents-by-contents basis or maybe on a periodic schedule basis. In short, the AI security media server system 600 in the present invention performs the function of enhancing the security of the meeting content while mediating the transmission of meeting contents such as multimedia among meeting participants 110, 210 as mentioned above.

For example, in FIG. 3, suppose that a meeting participant 210 mistakenly made a statement during the meeting about “ABC” that should not be communicated to the third party without the approval of the company's superiors. In this case, the voice data containing “ABC” from the meeting participant 210 is received from the meeting device 210 by the AI security media server system 600, i.e., the media server device 610, in the form of audio data packets converted from analog (e.g., human voice) into digital. In this case, the media server device 610 itself does not determine whether the received audio data contains enough contents to cause a security problem, but instead the media server device 610 immediately records the audio data in a security DB 620 and requests the AI security module 630 to analyze the audio data according to the first aspect of the present invention.

The AI Security module 630 is an artificial intelligence analysis tool that can analyze security risks through training that appropriately reflects security policies, and for example, the AI security module 630 illustrated in FIG. 3 has the function of setting a security breach index according to the prescribed security policy set by, for example, a company's security administrator. Here, “corporate security policies” can vary widely, and these security policies can be managed, changed, and discarded by AI security media server systems 600 over time if AI security media server system 600 secured an authority to do so from the company. Of course, by utilizing the generative AI capabilities of the AI security module 630 within the AI security media server system 600, it will be possible for the AI Security Module 630 to manage or change security policies tailored to a specific company itself, even without human intervention.

Let's assume that, among the company regulations of the company for which the participant 210 works, there is a security policy like “in the case of negotiating a deal with an expected transaction size of $1M or more, approval must be obtained at the executive level or higher before initiating negotiations or disclosing company materials to third party”, or “external sharing of sensitive information, including the customer's social security number, which is strictly controlled by the Personal Information Protection Act and the Information and Communications Network Act, etc., should be prohibited always, no matter what.” In addition, for example, remarks about the stability of batteries in electric vehicles, remarks about the risk of safety accidents that may occur when changing parts of the aircraft steering system, sharing of blueprints of newly released smartphones, sharing of demonstration video data related to unreleased infectious disease test kits, and the resident registration number of a specific resident in an apartment, etc., may be subject to the security protection by the present invention. Maybe such security protection may be required in compliance with social policies or laws. The AI security module 630 according to the present invention must be trained according to a specific situation to which the present invention is applied, in order to perform optimally. For reference, the method of setting several major keywords as the filtering criteria for security policy violations and filtering out only the contents that matches those keywords as contents with security risks might be one of many security measurements. Some of the security protection might need a real time security check. As far as the AI computing is not burdensome, it would be desirable to conduct security checks on virtually all types of multimedia content for meetings, such as text, images, videos, and voices.

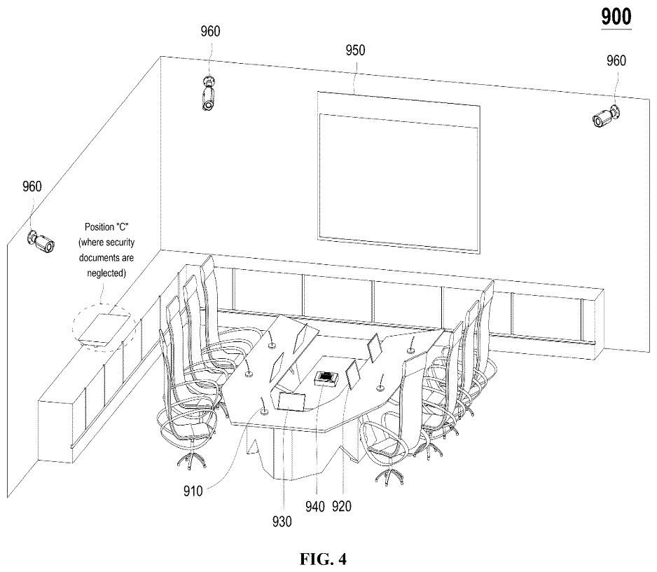

As shown in FIG. 3, in the AI meeting security system 1000 according to the present invention, before the risky remarks (that is, potentially violating the security policy) of the meeting participant 210 are transmitted following the direction A to a third party participant 110 outside the company, all remarks will be stored in a security DB 620 in real time and are subject to immediate security inspection by the AI security module 630, according to the first aspect of the present invention. According to the present invention, not only audio data such as conversations during a meeting, but also background screens (e.g., security documents left at location C in FIG. 4) filmed by a surveillance camera 960 in the conference room 900 (e.g., see FIG. 4) may be subject to security inspection, and all multimedia contents will be subject to security inspection by an AI security module 630 in real time to decide whether the security policy has been violated with regard to the meeting materials or talks.

Here, “real-time” includes network delay that may occur due to the AI security check that should be done by the AI security media server system 600. The AI security media server system 600 does not immediately complete the transmission and reception of contents between users 110, 210. Rather, it records the contents in a security DB 620 and then performs security inspection by the AI security module 630. Therefore, a situation may occur in which communication during the meeting is not smooth, due to the delay required by the security inspection process. In order to prevent this situation as much as possible, it is necessary to minimize the time that the media server device 610 holds the transmission and reception of multimedia contents. Therefore, it is desirable that the AI security media server system 600 according to the present invention includes not only a high-performance CPU (central processing unit) but also high-performance memories and GPU (graphics processing unit) that enables almost real-time meetings.

For reference, a GPU is a computer processor that renders images, videos, etc. through fast calculations, and in the case of the present invention, it is necessary to support the hardware performance of the AI security media server system 600 to some extent in order to analyze not only audio data but also video streams sent and received during video conferences. In this case, it may be possible to instantly determine and classify the security risk level of a particular image or streaming video by using the image-related processing tools included in the AI software (1300, see FIG. 8), for example. Even so, for example, the video streaming might look a bit slow to some participants. This is because only the meeting contents that passed the securely check can be transmitted to the other participant.

In addition, for example, by using the language processing tools included in the AI software (1300, see FIG. 8), the AI security media server system 600 may need to automatically translate the foreign language voice/text in addition to the default language set as the conference language, and sometimes it may be necessary to automatically convert all the speech into a text transcript and then perform a security analysis. In short, it is desirable that the hardware configuration of the AI security media server system 600 be high enough to support fast and accurate computation of AI software 1300.

The AI security module 630 allows the media server device 610 to immediately transmit the contents to the other party. e.g., 110 in FIG. 3, if the contents are classified as meeting contents irrelevant to security issues. In this case, the media server unit 610 may record the data related to the security check results of the AI security module 630 in a security DB 620, and if necessary, it may take measures to delete the content that has passed the security check from the security database 620. This is because if all multimedia contents of every single meeting should be stored permanently in a limited storage, the storage capacity of the security DB 620 according to the present invention should be unrealistically vast.

If the analysis result of the AI security module 630 exceeds a certain standard or threshold set by the present invention and it is determined that external sharing of the contents is not possible for the time being, the AI security module 630 may take measures to prevent the media server device 610 from transmitting the meeting contents that failed the AI security check to the meeting participants 110 who is a third party to the participant 210. In this case, the media server device 610 records the meeting contents that failed the AI security check in the log as a “security event” and records the information related to the meeting and the security event. For example, it is desirable to record in the security database 620 sufficient information to conduct a follow-up investigation, or “review.” For example, the IP address of an external meeting participant 110, the time when the security event occurred, the type of multimedia that the internal meeting participant 210 attempted to share, and the part related to the security breach (e.g., the part of the document that was violated or the video where the security problem occurred). The “security events” and “related information” recorded in this way should be accessible only if someone has the access rights to the security DB 620 (e.g., access permission only for users who meet password settings or internal rank conditions like CEO, etc.).

For reference, depending on the laws and social policies of the country to which the present invention applies, it may be necessary to configure the AI security module 630 to perform security functions in a two-way including both direction A and direction “B” in FIG. 3. In other words, security check might have to be performed on the contents transmitted from the external meeting participant 110 as well unless there is no privacy consent of the external meeting participant 110. For example, when the signaling server 700 forms a multimedia session between the meeting participants 110, 210, it notifies the external meeting participant 110 of a warning that “security censorship by the AI security media server system 600 may be carried out when participating in the conference, and security violations may be checked to see whether the meeting contents includes some security issues with regard to laws or company policies.” A two-way multimedia transmission and reception session may be set up between the meeting participants 110, 210 including direction A and direction B only if the outside meeting participants 110 agree to the above-exemplified privacy notice or warning. In this case, the AI security media server system 600 may need to verify the metadata information regarding whether the signaling server 700 has obtained the consent from the external meeting participants 110, and therefore it is desirable that a network channel is formed between the AI security media server system 600 and the signaling server 700 to transmit and receive signals with a predetermined protocol, and it may be more efficient if the configuration of the AI security media server system 600 and the signaling server 700 can be integrated as a single machine or software.

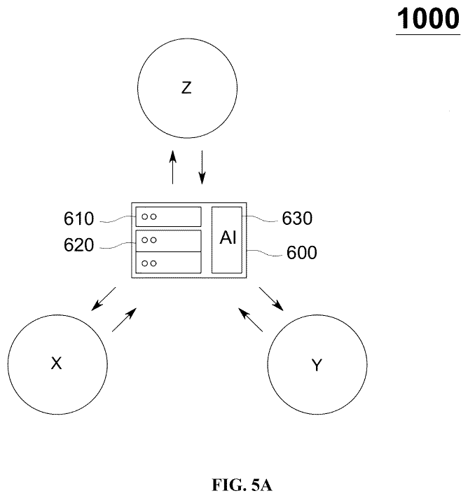

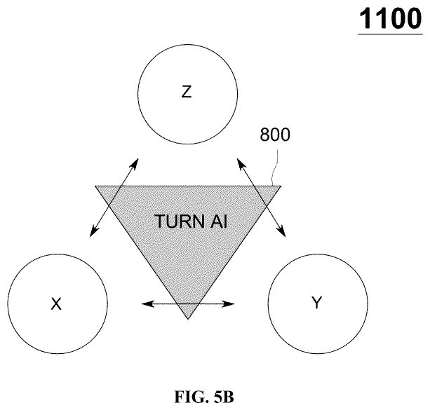

FIG. 4 is an illustrative drawing of an offline meeting system 900 (or conference room 900) to which an AI meeting security system 1000 in FIG. 5A or 1100 in FIG. 5B can be applied according to the first aspect of the present invention.

For example, an internal employee 210 participating in a meeting in FIG. 3 may hold the meeting in an offline conference room 900 like FIG. 4 while using the meeting device controlled by the meeting host device 930. In this case, the AI security media server system 600 in FIG. 3 may be interconnected to the offline conference system 900 in FIG. 4 by a network, or it may be implemented as an integrated including the AI security media server system 600 and the offline conference system 900. In other words, the functions of the offline conference system 900, which will be described below, can be integrated into the AI security media server system 600, and such integration may be desirable in terms of system efficiency. It should be noted that the offline conference system 900 to which the present invention can be applied, for example, premises that multimedia contents subject to the security check may include both the contents that the meeting participant 210 consciously wanted to share with the other participant 110 and the contents that the meeting participant 210 unconsciously shares with the other participant 110.

The offline conference system 900 includes a microprocessor that can process various data collected in the conference room 900 as exemplified in FIG. 4, a memory for temporarily or permanently storing the data, and an AI security media server system 600 or a network connection device for communicating with external third parties. If the AI security media server system 600 and the offline conference system 900 are integrated into a single device, then the configuration of these microprocessors, memory, and network-connected devices will be effectively shared between the media server system 600 function and the offline conference system 900 function.

In the offline conference system 900, the microprocessor can read or record data from the memory. If there is analog data among the collected data, ADC (Analog-to-Digital Converter) device may be further required to convert analog signal into digital data. The network connection device of the offline conference system 900 may be LAN (Local Area Network) or WAN (Wide Area Network) that supports TCP/IP (Transmission Control Protocol/Internet Protocol) protocols, Such network system may include wired network such as broadband cable, analog public switched telephone network (PSTN), and may also preferably include wireless fidelity (WIFI), Bluetooth™, and digital cellular network equipment, also known as 4G or 5G. Furthermore, it would be desirable if the network connection devices included in the offline conference system 900 in FIG. 4 include a gateway that enables communication between various networks using different communication protocols. Especially in case of remote meetings, it is important to build a meeting environment that can flexibly respond to a specific meeting situation due to the geographical location of the other party, and thus, various types of devices or protocols should be supported, which might not be used in the meeting organizer's country at all. Of course, the offline conference system 900 can include a firewall to block malware just like in FIG. 3.

Referring to FIG. 4 again, the offline conference system 900 is configured to collect various audio or video data generated during the conference by the ancillary equipment 910 to 960 shown in FIG. 4. For example, the conference room microphone 910 can be turned on and off depending on whether the user wants to speak or not, and background noise may be automatically removed when someone is speaking. The microphone 910 may be one of the devices responsible for collecting multimedia contents such as voice of the meeting attendees.

The conference room tablet computer 920 may include a touch screen that allows meeting attendees to visually check the content of the meeting while interacting with meeting participants through the touch screen functions. Of course, instead of a tablet PC 920 in the conference room, meeting participants may join the meeting with a laptop or smartphone brought directly to the conference room 900, which is not subject to the control of the host device 930. For reference, in the offline conference room 900, some contents may be shared between the participants instantly. Such instantly shared data may be subject to AI's security checks after the meeting is over.

The speakerphone 940 may be installed in an appropriate location inside the conference room 900 so that the speech of any and all participants can be heard well in the conference room 900. The speakerphone 940 can be the SIP hard phone mentioned above. Since the speakerphone 940 can continuously collect various noises and background sounds inside the conference room even when the microphone 910 is turned off, for example, the inadvertent remarks of some participant may be collected through the speakerphone 940. Such remarks will also be subject to security inspection by the AI security module 630.

The smart TV 950 installed in the center of the conference room 900 in FIG. 4 is designed to share the progress of the meeting with all the meeting participants in the conference room 900. Sometimes the screen of the TV 950 may be used to show the video of external participant to the remaining participants in the conference room 900. Usually, to call it a “meeting”, it refers to something that can be heard and reacted to by the other participants at the same time when one of the participants is speaking. Therefore, the smart TV 950 is designed to allow participants in the conference room 900 to share audiovisual data about the progress of the meeting simultaneously and express their opinions in real time if necessary. Of course, the smart TV 950 can increase the concentration level of meeting attendees.

The conference room camera 960 may be installed in various places in the conference room 900 as shown in FIG. 4. The camera 960 records and collects various situations that may occur in the conference room 900 with high-definition video data and maybe clear audio data. For example, the conference room camera 960 can support a variety of video formats and resolutions, such as CIF (Common Intermediate Format) 352×288 resolution, 4SIF (4*Source Input Format) 704×576 resolution, HD (High Definition) 1280×720 resolution, or FULL HD 1920×1080 resolution. For reference, the built-in camera (not shown) included in the aforementioned user terminals 100, 110, 200, 210 may also have similar or better camera performance in comparison to the conference room camera 960.

In addition, in FIG. 4, it may be assumed that an important drawing of new semiconductor is left unattended at position “C” in the conference room 900. There would be a security risk that the company's trade secrets might be shared with the other party during the video conference, especially when a third party participant can see the conference room 900 through the smart TV 950. In other words, the aforementioned “security event” is not only involved with the multimedia contents that the meeting participant consciously wanted to share. Rather, just like the case of semiconductor drawing left unbeknownst to anyone, the security event may be relevant to some contents that none of the meeting participants knew about. As long as the text, video or audio footage of the conference can contain such unconsciously disclosed information, such information would be subject to the security check, even if the security check might not be done in advance.

FIG. 5A and FIG. 5B are drawings for illustrating the principles of the AI meeting security system according to the first aspect of the present invention that can be realized in both the cloud-based central server system 1000 and the peer-to-peer connection system 1100, respectively.

First, in the case of FIG. 5A, the AI security media server system 600, which is substantially identical to that depicted in FIG. 3, represents a conference network structure in which the media transmission and reception between multiple meeting participants X, Y, and Z can be centrally handled. In the case of FIG. 5A, a signaling server 700 comprising a cloud server unit 710 and a cloud database 720 may also be integrated into an AI security media server system 600. In other words, according to the first embodiment, the AI security media server system 600 not only deals with the establishment of multimedia sessions between meeting participants X, Y, and Z, but also deals with media transmission and contents security. Thus, the cloud-based central server system 1000 in FIG. 5A includes the AI security media server system 600 with which the signaling server 700 is integrated. In FIG. 5A, the AI security media server system 600 acts as a “central server” for meeting participants X, Y, and Z, thus becoming the hub for audio and video streams between meeting participants.

Next, FIG. 5B shows that, unlike FIG. 5A, meeting participants X, Y, and Z are directly connected in a peer-to-peer manner as a multi-party meeting. Ideally, if a peer-to-peer session is established, a server may not be needed to mediate the transmission and reception of meeting contents. However, if X is the host of the broadcast conference on H.323, and Y and Z are the recipients of the broadcasted conference, then the conference organizer X will have to deal with many peer-to-peer connections. If there are many audiences other than Y and Z, the burden due to the peer-to-peer connection will be increased against X. In a technical perspective, such burden against X is a very inefficient example of network conferencing. Therefore, it is important to note that, even if there exist peer-to-peer connections, a media server may still be required to mediate the transmission and reception of multimedia meeting contents.

In addition, as discussed in WebRTC technology, for example, there may be any number of cases where direct peer-to-peer connection is difficult for any of the X, Y, or Z participating in the meeting due to, for example, firewalls. The network environment of the devices used by the participants in the meeting may be different, and there may be too many firewalls. In other words, the terminals of the meeting participants in FIG. 5B may not have an assigned public IP address. In such case, even if a peer-to-peer connection is established, direct content transmission between X, Y, and Z may not be possible, and to solve this practical problem, there is a process called “Interactive Connectivity Establishment (ICE)”, which recommends that the client send and receive audio and video streams through the media server. For example, in the case of a WebRTC open source project, which is substantially a conference standard in HTTP protocol environment, if it is difficult to connect directly between meeting participants due to firewalls, etc., TURN (Traversal Using Relays around NAT; Network Address Translation (NAT)) server transmits audio and video streams between meeting participants. For reference, NAT refers to the 1:1 conversion of each meeting participant's private IP into a public IP in order to allow two or more meeting participants to exchange data on the network. The TURN server is one of the servers that executes the above ICE process.

The present invention proposes that security inspection by AI software 1300 according to the present invention should be possible even in a peer-to-peer environment such as FIG. 5B. In other words, in a peer-to-peer environment such as FIG. 5B, it is proposed that operating the TURN server, which is responsible for transmitting and receiving media between X, Y, and Z, as a central server, is the most efficient method for realizing the security advancement of meeting contents according to the present invention. Thus, the peer-to-peer connection system 1100 according to the second embodiment of the first aspect of the present invention includes a TURN server 800 equipped with AI software 1300.

In FIG. 5B, it would be necessary to integrate the aforementioned TURN server and the AI security media server system 600 into a single device. Thus, the present invention defines that the server in the system 1100 in FIG. 5B is “TURN AI security media server 800” or simply “TURN AI 800”. The TURN AI security media server 800 is a configuration applicable to a peer-to-peer network and can be understood as a key component of the present invention.

FIG. 6 is a drawing representing the first aspect of the present invention in which AI meeting security is applied between two or more meeting participant devices 120, 220 while a multimedia session is established in a peer-to-peer manner. In FIG. 6, it is assumed that the peer-to-peer sessions between the meeting participants 120, 220 are formed by WebRTC technology, for example.

The aforementioned ICE is a framework that helps two terminals find the best route to communicate with each other. In order to support the smooth network connection of the client according to ICE, a TURN server or a Session Traversal Utilities for NAT (STUN) server is required, and the present invention suggests that the TURN server is more appropriate to be integrated with the AI security media server system 600 according to the present invention, rather than using the STUN server. It may be difficult to directly transmit contents between two terminals during peer-to-peer connections with the STUN server alone (for example, when two or more clients exist on the same network or in a symmetric NAT environment).

WebRTC technology, which supports the ICE framework, is an open-source project that enables browser-based peer-to-peer connections, generating SDP packets within the browsers of devices participating in the conference (e.g., 120 and 220), and then connecting two or more clients 120, 220 that want to join a conference using the signaling server and the WebSocket protocol created by the IETF. For reference, the WebSocket protocol is a protocol that allows reception of data without sending a REQUEST, unlike SIP. WebRTC's SDP is a text syntax that contains important information required to connect two or more devices, including information about the type of multimedia data (i.e., audio, video, text, and other formats), the type of codec used, and the various parameters supported by the browser. The SDP concept of WebRTC is not much different from the SDP concept of the SIP protocol discussed in FIG. 2A and FIG. 2B.

Referring to FIG. 6 again, the meeting participant 120 and the other meeting participant 220 completed the peer-to-peer connection with WebRTC technology, for example, but the firewall 641, 642 on both sides of the meeting participants 110, 220 makes it impossible to directly send and receive data between the meeting participants 120 and 220. In order to implement the security of the meeting contents according to the present invention, it is necessary to analyze the multimedia data packets sent and received between the meeting participants 120 and 220, which assumes that the multimedia contents are transmitted and received via a server including the AI module of the present invention.

Therefore, when installing the TURN AI security media server 800 as shown in FIG. 6, it is possible to smoothly transmit and receive multimedia between meeting participants 120 and 220. Furthermore, the TURN AI security media server 800 includes a media server device corresponding to the media server unit 610 in FIG. 3, AI security module corresponding to the media server unit 630 in FIG. 3, and the security DB corresponding to the security DB 620 in FIG. 3. The AI security module included in the TURN AI 800 enables security checking of meeting contents by virtually the same process as described in FIG. 3. However, since the media server unit, the security database, and the AI security module included in the TURN AI security media server 800 are substantially identical or corresponding to the media server unit 610, security DB 620, and AI security module 630 in FIG. 3, further explanations of these configurations will be omitted here.

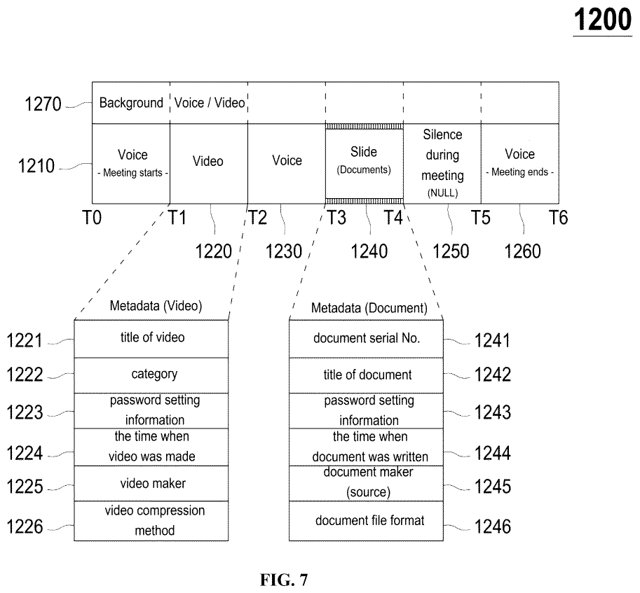

FIG. 7 is a drawing for illustratively showing the packet structure 1200 of a multimedia contents that may be subject to an AI meeting security inspection according to the first aspect of the present invention.

As described above, meeting contents having multimedia type may be sent and received in the form of data packets between meeting participants (e.g., 100, 110, 120, 200, 210, 220, or X, Y, Z). A multimedia packet 1200 may consist of documents, audio or video data, or a combination thereof as exemplified in FIG. 7. In addition, individual packets 1210 to 1260, which are usually directly related to the meeting, can be divided into based on the time when each packet 1210 to 1260 was requested to be transmitted. For example, if a meeting participant 210 in FIG. 3 speaks first when the meeting is started, the voice data of the meeting participant 210 can constitute a first media packet 1210 covering a timeline from time T0 to T1.

The multimedia contents subject to security inspection in the present invention are not only the contents shared by the meeting participants 100, 110, 120, 200, 210, 220, or X, Y, Z for the purpose of the meeting, but also the background footage or background noise. This background data unconsciously shared with other participants can be one of the multimedia contents throughout the timeline from time T0 to T6. However, it would be desirable to implement the “real-time” AI analysis where the AI security module included in the AI security module 630 or the TURN AI security media server 800 can simultaneously analyze the meeting contents throughout the timeline in FIG. 7. Such real-time AI analysis should include the background data 1270. Sometimes it might be useful to divide the target contents into consciously shared data packets 1210, 1220, 1230, 1240, 1250, 1260 and unconsciously shared data packet 1270.

It is important to note that the time interval between T0 and T6 may not exactly correspond to the amount of content in each meeting. For example, it may be necessary to split the remarks made by a meeting participant and have to be checked by AI software 1300. In the case of the present invention, for the security inspection of multimedia data transmitted and received from meeting participants 100, 110, 120, 200, 210, 220, or X, Y, Z, etc., there is a standby state in which the AI security media server system 600 or the TURN AI security media server 800 waits for the check result of the AI software 1300 without completing the multimedia transmission and reception, and in order to realize a real-time conference at a level where communication delay is difficult to feel by minimizing this waiting state, it may be required to break down the analysis of AI software 1300 into a certain file size unit. Of course, if the meeting is not a big problem due to waiting and communication delays due to AI analysis, the time T0, T1, . . . , and T6 settings can be made in terms of the speaker's speech unit, presentation unit, or shared meeting video unit.

In addition, the actual meeting contents, e.g., 1210, mentioned above may be voice data input by the conference room microphone 910 in FIG. 4, and the background data 1270 may be audio and video data input by the speakerphone 940 or conference room camera 960 in FIG. 4. For reference, even during a meeting, there may not be much conversation between meeting participants, in which case, for example, packets between time T4 and T5 can be treated as NULL items that might be excluded from security checks, reducing the computational burden on AI software 1300.

However, despite the above explanation, in the case of FIG. 7, for example, the time T1 to T2 corresponds to the video data packet 1220 taken by the conference room camera 960 of the meeting participants who are speaking at the meeting. Similarly, the time T2 to T3 is shown as the voice data packet 1230 of another speaker, and the time T3 to T4 is set by content to correspond to the slide presentation data 1240 prepared by another speaker.

In FIG. 7, in the case of multimedia contents packet 1200, metadata can be included in data packets divided by time. For example, video data 1220 shared from time T1 to T2 may be tagged in the form of metadata about the title of the video 1221, category 1222, password information set in the video file 1223, the time when the video was created 1224, the creator information of the video 1225 (including camera footage automatically taken by conference room camera), and how the video was compressed 1226 such as High Efficiency Video Coding (HEVC).

Similarly, for slide presentation data 1240 from time T3 to T4, metadata such as slide document number 1241, slide title 1242, password information set on the slide 1243, slide creation time 1244, slide author information 1245, document type 1246, etc. can be tagged. Note that these metadata information may be information already tagged in the content, or may be self-generated by the AI software 1300 under the present invention for the purpose of security inspection, or security check.

If the “security event” occurs between time T1 and T2, the AI security media server 600 or the TURN AI security media server 800 according to the present invention may allow the transmission of the meeting contents during the timeline from T1 to T2 except for the portion of the multimedia packet 1220 that contains the security event.

FIG. 8 is an illustrative drawing showing the overall configuration of AI software that can be adopted to implement the security inspection function of the AI security module, the SDP failure resolution function, or the SIP supplementing function according to the present invention in general. In other words, the AI software 1300 operates as an “AI security module” within the AI security media server 600 or the TURN AI security media server 800 in case of the first aspect of the present invention.

In case of the AI software 1300, “AI” refers to the ability of a computer to think and learn. The AI software 1300 usually has to go through various processes such as (i) problem definition, (ii) data acquisition and preparation, (iii) model development and training, (iv) model evaluation and refinement, (v) deployment of AI in actual products, and (vi) execution of machine learning operations. Since these processes are not completely independent of each other, but are interlinked, it may be desirable for the AI software 1300 to be communicable with an external third server (not shown) to efficiently assist the AI computing process, rather than limiting the AI's capacity to a pre-defined performance. In addition, as already described, in the case of the present invention, both the cloud-based central server method (see FIG. 5A) and the peer-to-peer communication method (see FIG. 5B and FIG. 6) can use the AI software 1300 as part of the AI security media server 600 or the TURN AI security media server 800.

Referring to FIG. 8 again, the AI software 1300 according to the present invention may include a generative AI tool 1310. The generative AI tool 1310 is responsible for receiving training data input and creating similar text, images, or media based on the patterns and structures of the input training data. In the case of the present invention, a generative AI tool 1310 can be used when generating metadata related to a multimedia contents packet 1200 that are subject to security inspection as shown in FIG. 7.

Further, the present invention comprises a large language model (LLM) 1311 as a sub-model. As mentioned earlier, the multimedia data packet 1200 can contain a variety of formats, so it is possible to use the Multimodal Foundation Model (MFM) 1312 in connection with the generative AI tool 1310.

Meanwhile, the AI software 1300 is a significant improvement in machine learning (ML) tool 1320. For example, in order to execute a mobile video conference, the camera mounted on the user's smartphone 100, 200 is used, and the video data entered by the smartphone camera is subject to security inspection by AI software 1300. In order to accurately analyze images and videos, it is necessary for the AI 1300 to be trained in advance with a large amount of machine learning training dataset.

As shown in FIG. 8, a machine learning tool 1320 may adopt a deep learning (DL) model 1321 that analyzes a given data by dividing the data into multiple layers. In addition, a supervised learning model 1322 can be adopted, including learning modeling, which inputs the desired analysis results in advance to induce the AI to produce output that better matches with the user's intent. By entering the expected value in advance before the AI's computation, the AI software 1300 may learn what kind of result would be desirable. On the other hand, it is also possible to adopt an unsupervised learning model 1323 in which the AI software 1300 imitates the training data on the neural network without having input of expected results in advance.

In addition, the AI software 1300 according to the present invention includes a natural language processing (NLP) tools 1330. This is because, due to the nature of the meeting, the meeting contents to be analyzed in the present invention will include a large number of human language.

The NLP tool 1330 may adopt a natural language understanding (NLU) model 1331 that allows machines to interpret a given sentence using lexicon, parsing, and grammar rules. Natural language generation (NLG) model 1332 may also be required for AI security analysis pursuant to the present invention.

Further, the AI software 1300 according to the present invention includes a computer vision tool 1340. Since the present invention is configured to perform the security checks during video conferences, a computer vision tool 1340 for video data analysis may be essential for the AI software 1300.

In the case of computer vision tool 1340, it is desirable to use an object detection model 1341 that appropriately extracts only the objects necessary for the security inspection of the conference. For example, the AI software 1300 can be set to exclude the meeting room walls without any markings in the offline conference room 900 from the security inspection. For this purpose, the AI software 1300 must be able to distinguish which part of the video data recognized by the camera 960 is the wall and which part is something other than wall.

The scene understanding model 1342 is also one of the AI models that can be adopted in computer vision tool 1340. The scene understanding model 1342 performs AI analysis on which objects in an image or video should be treated more importantly, and which objects have a certain level of importance or priority over others. From the machine's point of view, it may be just a set of pixels, but one of the roles of the scene understanding model 1342 can be to support the AI software 1300 to give priority to the semiconductor design drawing placed at position C in FIG. 4. Prioritizing analysis for each conference multimedia contents during security checks can affect the total amount of computation, computational speed, and even system efficiency of the AI software 1300.

The Face Detection and Recognition model 1343 may be required for the analysis of the faces, facial expressions, and mouth shapes of the meeting participants 110, 210 during video conferencing. This technology is an AI technology used in social media, photo cleaning apps, facial recognition security entry, and even criminal investigations, and can infer the age of the person being analyzed (e.g., the pupil reflex gets darker with age), gender, and emotions from facial expressions and appearance. If the security event is caused by a statement made by an external meeting participant 110 in FIG. 3, the results of the AI facial analysis of the external meeting participant 110 can be useful when reviewing the security event after the meeting is over.

The analysis results of the Eye and Gaze Tracking model 1344 may be used as incidental data in the security inspection of the present invention, and in addition, in the case of video conferencing, for example, it may be used in video conferencing as data to determine whether the meeting participants 110, 210 are properly concentrating on the meeting, regardless of the security inspection. Eye and eye tracking models 1344 can be divided into two sub-fields. One is to determine the position of the eyes (“eye localization”), and the other is to find out the direction of the eye's gaze (Gaze Estimation). For reference, in eye analysis using AI, “eye” mainly refers to the pupil (including both dark pupil and bright pupil) and iris, and in addition to pixel data about the pupil and iris, eye analysis also uses images or video information related to corneal reflection (Iris Reflection), limbus, pupil contour, and eyelid. In other words, eye localization focuses on accurately judging the existence and position of the human eye in a given image or video, and it can be said that it is gaze estimation that focuses on analyzing the position of the eye in each frame of the image or video and finding out the person's current gaze and the direction of its movement in three-dimensional space. In addition, it may be difficult to treat eye tracking models and eye tracking models equally. However, from the perspective of eye oculography, it is also possible to combine the two models and treat them as an eye and gaze tracking model 1344 as shown in FIG. 8.

For reference, when tracking the eye of a meeting attendee using AI software 1300, information about the position and posture of the meeting attendee's head may be referred. This information can be extracted, for example, from high-definition video data taken by one of the camera 960 shown in FIG. 4 from an appropriate angle.

In short, the present invention proposes to adopt an eye and eye tracking model 1344 for the purpose of comprehensively analyzing information about the face, facial expression, body or head posture of the meeting participants, rather than simply performing AI analysis of the eyes of the meeting participants by means of an eye and eye tracking model 1344. Of course, if such eyeball/gaze analysis data is not necessary for the security inspection of the meeting contents, the eyeball and gaze tracking model 1344 may be unnecessary.

As shown in FIG. 8, computer vision tools 1340 may include the motion analysis model 1345. For example, depending on the head position of the meeting attendees captured on the conference room camera 960 in FIG. 4, the eyelids can sometimes be seen as straight and sometimes oval in a single image, so defining parameters such as the shape of the eyelids as a certain shape may lead to errors in accurate gaze analysis. The motion analysis model 1345 is a technique for determining what actions are performed in the recorded video based on two or more continuous image sequences made by the camera that shoots the video, and such motion analysis data may be required for precise calculations of the eye and eye tracking model 1344.

The computer vision tool 1340 may adopt text recognition models, such as optical character recognition (OCR) model 1346. For example, if the camera mounted on the smartphone 100, 110, 200, 210 used by the meeting participants may capture a large amount of text (research notes, slides, marketing strategy documents, etc.) in the background of the user. Thus, such OCR data may be useful to assist AI analysis to some extent as an auxiliary means of the aforementioned scene understanding model 1342.

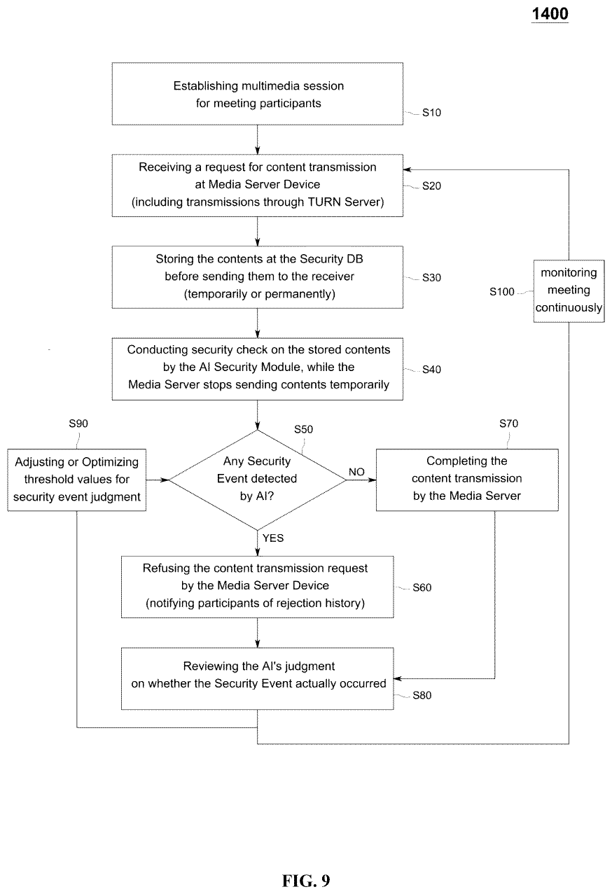

FIG. 9 is a flowchart representing an illustrative algorithm 1400 for executing the security improvement of meeting contents in an AI meeting security system 1000 or 1100 according to the first aspect of the present invention.

Referring to FIG. 9, in step S10, a multimedia session for two or more terminals 100 and 200 will be established. This process may use the SIP protocol as illustrated in FIG. 1, FIG. 2A, and FIG. 2B, or using the signaling server 700 and WebRTC technology, or using the H.323 standard, as illustrated in FIG. 3. Of course, step S10 involves the exchange of SDP information (or the corresponding information even if the name SDP is not used according to the protocol) between two or more terminals 100 and 200 in FIG. 1, for example.

In step S20, the media server unit 610 of the security media server system 600 or the media server device in the TURN AI security media server 800 is requested to send multimedia contents packet 1200 from terminal 100 or 200. For reference, even in the case of a peer-to-peer session as shown in FIG. 5B, the present invention transmits a multimedia contents packet 1200 via the TURN AI security media server 800. In addition, multimedia contents packet 1200 may be collected directly from two or more terminals 100, 200 participating in the conference, but they may also be content collected by incidental data acquisition equipment 910 to 960 in the conference room (900) as already exemplified with reference to FIG. 4.

In step S30, the media server device 610 of the security media server system 600 or the media server device in the TURN AI security media server 800 temporarily stores the requested data packet 1200 sent at step S20 in the security DB 620 or the security DB of the TURN AI security media server 800 to prepare for security inspection of the meeting contents according to the present invention. At this stage, the other party has not yet received the contents of the meeting. Storing meeting contents in a security DB may be temporary, but it may be possible to store meeting content permanently or semi-permanently if necessary.

In step S40, the AI security module in the TURN AI security media server 800 or the AI Security module 630 runs the AI software 1300 to perform a “security check” on the target packet (e.g., 1200 or 1210 to 1270 individually) and may determine whether the packet 1200 or 1210 to 1270 is at risk of raising a “security event.” For reference, if content can be shared only with the above-mentioned “executive-level approval”, the security event judgment may be made based on whether the meeting participants have presented materials that can prove the approval of the executive director or higher.

In step S50, the AI security module in the TURN AI security media server 800 or the AI security module 630 applies a pre-set security policy to the media packet 1200 or 1210 to 1270 to determine whether the security risk exceeds a threshold.

If, at step S50, it is determined that a security risk exists, the TURN AI security media server 800 or the media server device 610 will not forward the data packet 1200 to the other party of the meeting in step S60. If necessary, the AI system may notify the sender of such transmission failure in the form of an email or instant message.

If, at step S50, it is determined that no security risk exists, the media server device in the TURN AI security media server 800 or media server device 610 will successfully transmit the data packet 1200 to the other party of the meeting in step S70. Of course, the transmission of data packet 1200 may be transmitted “in (almost) real time,” but to do this, the security media server system 600 or TURN AI security media server 800 should be capable of high-performance AI computing.

It is important to note that inevitably some amount of time may be required to complete step S30 or step S50, depending on the performance of the AI system performances. In some cases, it might not be possible to achieve real-time transmission with zero latency when transmitting packets 1200 at step S70.

In step S80, the AI software 1300 performs self-evaluation process. That is, AI software 1300 may learn whether the security inspection results of the TURN AI security media server 800 or the AI Security module 630 are consistent with the actual, or real-world analysis results. At this stage, whether there was a security event would not be important to AI because AI wants to know whether AI's prediction was correct. Even if the AI software 1300 predicts that it is a security breach (hereinafter referred to as “Positive” or “P”), the reality may show the same conclusion in step S80 (i.e., this is called “True Positive, TP”), or the reality may show that AI's prediction on security event was wrong (i.e., it is called “False Positive, FP”).

Similarly, for example, when the AI software 1300 predicts that it is “not a security breach (hereinafter referred to as “Negative” or “N”), the step S80 may show the same conclusion (i.e., this is called “True Negative, TN”), or the reality may show that a security breach occurred during the review (i.e., it may be called “False Negative, FN”). Here, it should be noted that the AI software 1300 may learn the actual result when the security administrator or human inspector notified the actual result to AI.

TABLE 1

Actual

| | | P | N |
|---|---|---|---|
| AI | P | TP | FP |
| Prediction | N | FN | TN |

In the ML tool 1320 described in FIG. 8 above, the results shown in step S80 above can be summarized into a confusion matrix as shown in Table 1.

In Table 1, “Class” can be understood as two classes in the case of the present invention: “security event occurred” class and “no security event” class. The important thing in AI technology is to improve the mistakes made by AI, and in the case of the present invention, it is proposed that the accuracy of AI security prediction can be improved by using the confusion matrix.

With regard to the confusion matrix analysis, “Accuracy” represents the proportion of TP and TN among all data packets sent and received via the media server system 600 or the TURN AI security media server 800 in the present invention, that is, the percentage that the AI predicts that the security event is correct or not. To convert the confusion matrix data into a mathematical result, the following technique may be required:

$$( Accuracy ) = \frac{TP + TN}{TP + FN + FP + TN} \qquad Equation ( 1 )$$

$$( Recall ) = \frac{TP}{TP + FN}$$

$$( Precision ) = \frac{TP}{TP + FP}$$

$$TPR = \frac{TP}{TP + FN} \qquad FPR = \frac{FP}{FP + TN}$$

Here, “Recall” focuses on column P in Table 1, which refers to the percentage of items that the AI correctly predicts that the security event is correct among the items that should be concluded to be true that the actual security event is correct. “Precision” focuses on the P row in Table 1 above, which indicates the percentage of the AI software 1300 predicting a security event that actually turns out to be true. In addition, the above “TPR (True Positive Rate)” is the same value as the recall. The higher P rate may mean the better AI performance. For reference, the “FPR (False Positive Rate)” is the rate at which the AI incorrectly predicted it as a security event even though it is not actually a security event. In addition, a technique called G-Mean may be adopted in the present invention by using the following equation:

$$G - Mean = \sqrt{TPR \times ( 1 - FPR )} \qquad Equation ( 2 )$$

Here, the present invention proposes an algorithm for adjusting the reference value of the class judgment in step S90 in FIG. 9 as in mathematical equation (2).

If most of the total cases reviewed are found to be non-security events, it is advisable to apply machine learning based on Imbalanced Classification to the AI software 1300. In short, in the case of the present invention, assuming that there are not so many security breaches among the total number of meetings, a method is proposed to continuously adjust and optimize the judgment threshold of security events initially set by the AI software 1300 according to the geometric mean or G-Mean technique as described in mathematical Equation (2).

Normally, when classifying data by AI, 0.5 is often set as the default value for the classification threshold, where 0.5 means that the AI will conclude that the security risk analysis calculated with a value higher than 0.5 is a security event, and the AI will conclude that the security risk prediction calculated at a value lower than 0.5 is not a security event.

Of course, by combining various sub-tools and models of the AI software 1300 mentioned in FIG. 8 above, for example, the AI can determine that the background video footage is irrelevant to company's secret, and this judgment can be accurate. However, since the judgment of the AI software 1300 cannot always be accurate, it is necessary to adjust the threshold of the AI judgment as in step S90. To this end, the present invention proposes a method of adjusting the threshold value of class classification by a geometric average technique with “assuming an unbalanced class during the security inspection of meeting contents.”

Meanwhile, in FIG. 9, in parallel with step S90, the AI software 1300 continuously monitors the meeting contents at step S100 and performs security checks on data packets 1200. In other words, step S100 reverts back to step S20 and the media server device in the TURN AI security media server 800 or the media server device 610 continues to receive the next multimedia packet to be sent between the meeting participants. The step S100 may be the starting point of algorithm 1400. For example, if a session between meeting participants ends early for some reason, it may be possible to repeat the procedure discussed in FIG. 1 by re-forming the session among meeting participants.

In summary, the first aspect of the present invention suggests a computer-implemented method to enable a meeting contents security service by using an AI in a multimedia session established for two or more meeting devices, comprising: receiving a multimedia contents packet from a first meeting device among the two or more meeting devices with a transmission request to transmit the multimedia contents packet to a second meeting device among the two or more meeting devices, by a media security server; storing the received multimedia contents packet in a security DB and waiting by the media security server for a result of a security check performed by an AI security module, before transmitting the received multimedia contents packet pursuant; making an AI decision on whether a security risk level of the multimedia contents packet exceeds a predetermined security risk threshold based on a predetermined security policy, by the AI security module; and rejecting the transmission request when the AI security module decides that the security risk level exceeds the security risk threshold and notifying the first meeting device on a real-time basis of a failure response regarding the transmission request, by the media security server.

In the computer-implemented method according to the first aspect of the present invention, the first meeting device and the second meeting device may be connected in a peer-to-peer manner, and the media security server may be a TURN (Traversal Using Relays around NAT) server running an ICE (Interactive Connectivity Establishment) framework.

In the computer-implemented method of according to the first aspect of the present invention, the multimedia session between the first meeting device and the second meeting device may be established by a signaling server.

In the computer-implemented method according to the first aspect of the present invention, the two or more meeting devices may use the media security server as a central server responsible for transmitting and receiving the multimedia contents packet between the two or more meeting devices by a cloud network environment.

In the computer-implemented method according to the first aspect of the present invention, the method may further comprise calculating a confusion matrix based on whether the AI decision corresponds to an actual result of the security check on the multimedia contents packet after the AI decision is made; and adjusting for optimization the security risk threshold by using a geometric mean technique applied for an imbalanced classification, by the AI security module.

The first aspect of the present invention may be implemented as a server system to enable a meeting contents security service by using an AI in a multimedia session established for two or more meeting devices, comprising: a media security server that receives a multimedia contents packet from a first meeting device among the two or more meeting devices with a transmission request to transmit the multimedia contents packet to a second meeting device among the two or more meeting devices; a security DB that stores the multimedia contents packet received by the media security server and restricts an external access thereon; and an AI security module that performs a security check by making an AI decision on whether a security risk level of the multimedia contents packet stored in the security DB exceeds a predetermined security risk threshold based on a predetermined security policy, wherein the media security server gives a permission to the transmission request only when the security risk level of the multimedia contents packet is decided not to exceed the security risk threshold.

In the server system according to the first aspect of the present invention, the first meeting device and the second meeting device may be connected in a peer-to-peer manner, and the media security server is a TURN (Traversal Using Relays around NAT) server running an ICE (Interactive Connectivity Establishment) framework.

In the server system according to the first aspect of the present invention, the system may further include a signaling server that establishes the multimedia session between the first meeting device and the second meeting device.

In the server system according to the first aspect of the present invention, the two or more meeting devices may use the media security server as a central server responsible for transmitting and receiving the multimedia contents packet between the two or more meeting devices by a cloud network environment.

In the server system according to the first aspect of the present invention, the AI security module may calculate a confusion matrix based on whether the AI decision corresponds to an actual result of the security check on the multimedia contents packet after the AI decision is made, and may adjust for optimization the security risk threshold by using a geometric mean technique applied for an imbalanced classification.

### Second Aspect of the Present Invention

According to RFC-8866, a session description is a text format defined to inform other devices of sufficient information required for a device to search for a multimedia session and participate in that session. The Media Description contains the information required for one of the session participants, e.g., 100 and 200, to set up an application-layer network protocol connection (e.g., peer-to-peer connection according to the SIP protocol in FIG. 1) to the other. SDP field names and attributes are mostly written as strings belonging to the aforementioned UTF-8.

SIP, as illustrated in FIG. 1, is an application layer control protocol used to create, modify, and terminate sessions for Internet multimedia conferences, Internet telephony, multimedia distribution, etc. In the case of SIP, session descriptions are used to allow both parties to communicate to agree on behavior and compatible media types. In this regard, the “Offer/Answer Model” defined in RFC-3264, another document of the IETF, represents an example of a negotiation framework using SDP, and FIGS. 2A and 2B also provide simple examples of such negotiation frameworks.

RTSP (Real-Time Streaming Protocol) is an application-level protocol specified in RFC-7826 for controlling the transmission of data in real time. Here, real-time data includes audio and video. In RTSP, the client and server negotiate a set of parameters for media delivery, using part of the SDP syntax.

Another way to deliver session descriptions is the widely used email and the World Wide Web (WWW). In this case, the SDP syntax part where the media type is listed uses the expression “application/sdp.”

As such, the purpose of an SDP is to convey information about the media stream belonging to a multimedia session, so that the recipient of the session description can participate in that session. In other words, it can be understood that the basic purpose of the SDP protocol is to inform the other party that a specific session exists and to convey sufficient information (except for security/encryption related matters required to participate in the session, which is usually excluded) so that they can participate in the session. SDP is designed to be used with the internet Protocol (IP), but it is versatile enough to work on other networks.

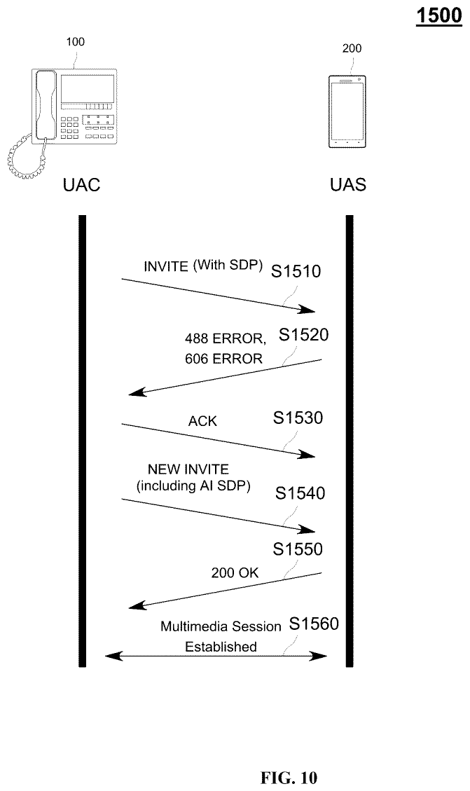

FIG. 10 is a drawing to illustrate a method for compensating for SDP failures using AI based on the first embodiment 1500 of the second aspect according to the present invention.

The SDP may include the name and purpose of the session, the time the session is active, the media that makes up the session, and the information required to receive such media (address, port, format, etc.). In addition, the SDP session description may additionally include information about the bandwidth used for the session (i.e., the limit of how much a particular network can transmit data) or the contact information of the person managing the session.

Here, media information includes the type of media (whether it is video or audio, etc.), the media transmission protocol (RTP/UDP/IP, H.320, etc.), and the format of the media (H.261 video, MPEG video, etc.). For IP multicast sessions, SDP will include the multicast group address for the media and the media's transmission port information.

TABLE 2

| | encoding | media | clock rate | |
|---|---|---|---|---|
| PT | name | type | (Hz) | channels |
| 0 | PCMU | A | 8,000 | 1 |
| 1 | reserved | A | | |
| 2 | reserved | A | | |
| 3 | GSM | A | 8,000 | 1 |
| 4 | G723 | A | 8,000 | 1 |
| 5 | DVI4 | A | 8,000 | 1 |
| 6 | DVI4 | A | 16,000 | 1 |
| 7 | LPC | A | 8,000 | 1 |
| 8 | PCMA | A | 8,000 | 1 |
| 9 | G722 | A | 8,000 | 1 |
| 10 | L16 | A | 44,100 | 2 |
| 11 | L16 | A | 44,100 | 1 |
| 12 | QCELP | A | 8,000 | 1 |
| 13 | CN | A | 8,000 | 1 |
| 14 | MPA | A | 90,000 | (see text) |
| 15 | G728 | A | 8,000 | 1 |
| 16 | DVI4 | A | 11,025 | 1 |
| 17 | DVI4 | A | 22,050 | 1 |
| 18 | G729 | A | 8,000 | 1 |
| 19 | reserved | A | | |
| 20 | unassigned | A | | |
| 21 | unassigned | A | | |
| 22 | unassigned | A | | |
| 23 | unassigned | A | | |
| dyn | G726-40 | A | 8,000 | 1 |
| dyn | G726-32 | A | 8,000 | 1 |
| dyn | G726-24 | A | 8,000 | 1 |
| dyn | G726-16 | A | 8,000 | 1 |
| dyn | G729D | A | 8,000 | 1 |
| dyn | G729E | A | 8,000 | 1 |
| dyn | GSM-EFR | A | 8,000 | 1 |
| dyn | L8 | A | var. | var. |
| dyn | RED | A | | (see text) |
| dyn | VDVI | A | var. | 1 |

For example, at step 1510 of FIG. 10, the UAC 100 sends an INVITE message to UAS 200 and includes the SDP information. In this case, the SDP includes syntax such as “m=audio 1234 RTP/AVP 8 0 18 98”. Here, the phrase “m=” means media description, “audio” indicates that the session is of the audio type, and 1234 indicates the port number. “RTP/AVP” means that the protocol used in multimedia sessions will use the Audio Video Profile (AVP) of the Real-time Transport Protocol (RTP). Each number of “8, 0, 18, 98” that follows represents a specific codec, 8, 0, . . . . The numerical order of the number indicates the priority of the codec to be used. RFC-3551, published in July 2003, details the “RTP/AVP” profile, and according to this document, Tables 2 and 3 can be used to interpret the above numbers.

TABLE 3

| | encoding | media | clock rate |
|---|---|---|---|
| PT | name | type | (Hz) |
| 24 | unassigned | V | |
| 25 | CelB | V | 90,000 |
| 26 | JPEG | V | 90,000 |
| 27 | unassigned | V | |
| 28 | nv | V | 90,000 |
| 29 | unassigned | V | |
| 30 | unassigned | V | |
| 31 | H261 | V | 90,000 |
| 32 | MPV | V | 90,000 |
| 33 | MP2T | AV | 90,000 |
| 34 | H263 | V | 90,000 |
| 35-71 | unassigned | ? | |
| 72-76 | reserved | N/A | N/A |
| 77-95 | unassigned | ? | |
| 96-127 | dynamic | ? | |
| dyn | H263-1998 | V | 90,000 |

In other words, Table 2 is a direct quote from the table presented in Section 6 of RFC-3551, indicating the payload type (PT) for audio encoding, and Table 3 is also a quote from the table presented in Section 6 of RFC-3551, indicating the payload type for encoding video and its combined media. Here, the payload can be understood as the message that should be communicated, that is, the content of the text.

Looking at the example “m=audio 1234 RTP/AVP 8 0 18 98”, the payload type of 8 means that the Pulse Code Modulation A-law (PCMA) codec will be used as a top priority when referring to Table 2. PCMA is one of the G.711 codecs developed for telephones, and is a general-purpose audio codec mainly used outside of North America. The “0” after “8” means that the PCMU (Pulse Code Modulation μ-law) codec will be used next to PCMA when referring to Table 2. PCMU is a G.711 audio codec used primarily in North America and Japan. “18” refers to the G.729 codec when referring to Table 2, which is a codec that has higher compression performance than G.711 but has the potential to degrade audio quality if the data is encoded and decoded repeatedly and repeatedly. “98” refers to the dynamic format when referring to Table 3, and according to RFC-3551, payload types 96 to 127 are PT numbers set aside for dynamic formatting, meaning new or non-traditional encoding techniques that can be dynamically assigned from session to session (e.g., when combining the encoding techniques presented in Tables 2 and 3). Therefore, the number “98” can be redefined depending on the session, and since it does not refer to absolutely any encoding technology, it can also be reused in other situations.

Therefore, for example, if the sender 100 is located in South Korea and the recipient 200 is in North America, and the media description part of the SDP message sent by the sender 100 is written with a phrase such as “m=audio 1234 RTP/AVP 0 98”, there is a possibility that the “488” error message will be replied as shown in step S20 in FIG. 10. This is because the recipient 200 may want to use the more general “8” PT code for teleconference calls between the different continents, Korea and North America.

FIG. 10 depicts a situation where the session connection fails due to an SDP problem.

For reference, according to RFC-3261, in the SIP protocol, “4xx” messages refer to failure messages sent by UAS. Among them, “488” means “Not Acceptable Here”. Of course, there are various error messages in the SIP protocol, for example, the “6xx” message indicates a “Global Failure” situation that is not limited to a specific URI or region, and “606” means that the recipient cannot accept the suggestion of media or bandwidth contained in the SDP. “488” and “606” have the same meaning, but the “606” error message is more widely applied regardless of the URI and has a final nature.

In the case of the present invention, the above SDP message analysis is eventually executed by an AI SDP application according to the present invention, and the AI SDP application may be configured, including, for example, the AI software 1300.

The important point in FIG. 10 is that the establishment of a multimedia session between the sender and receiver 100, 200 failed at step S1520 of FIG. 10.

In addition, if a conversation between the sender and receiver 100, 200 is established, various parameters can be adjusted through the SIP message transmission called “RE-INVITE”. However, if a message such as “488” or “606” is replied due to the failure of the SDP negotiation before the dialogue between the sender and receiver 100 and 200 is established, as in step S1520, the sender 100 replies to the ACK message in step S1530 and the SIP transaction is terminated. In other words, at step S1530, the sender 100 cannot retransmit the RE-INVITE message.

Next, the step S1540 is the core of the present invention, which can be executed by installing an AI SDP application according to the present invention on the UAC 100. As mentioned above, in the present invention, the “AI SDP application” is an artificial intelligence software installed on a UA (that is, UAC AND UAS all, including 100, 200) terminals, and the artificial intelligence may be configured especially for step S1540.

The core function of the AI SDP application installed on the sender side of the present invention is that if the sender 100 receives a message of session connection failure due to an SDP problem, as shown in step S1520 of FIG. 10, the AI software 1300 installed on the sender 100 side analyzes the cause of the failure, especially by the generative AI tool 1310 and the machine learning tool 1320 among the AI software 1300. The purpose of using AI is to write a SDP syntax and send a new INVITE (i.e., New INVITE) message to the recipient 200.

How to compensate for the SDP failure that occurred in step S1520 will be shown in step S1540.

For example, if the sender 100 and receiver 200 are located on different continents, the AI software 1300 may modify the phrase “m=audio 1234 RTP/AVP 0 98” in the SDP message sent by step S1510 to such as “m=audio 1234 RTP/AVP 8 0 98”, i.e., designate payload type 8 that is universally available on both continents as the first priority, and then retry the SIP INVITE transaction through step S1540 according to the first embodiment 1500. Of course, there is no guarantee that such a transaction attempt will be successful.

As seen in Table 2 above, the number “8” contained in the SDP message “m=audio 1234 RTP/AVP 8 0 98” in the new INVITE is a general-purpose PCMA audio codec mainly used outside of North America, so if the sender 100 is attempting an audio-type conference call, the AI SDP application (including the AI software 1300) installed on the sender side of the present invention learns the RFC-3551 standard and various execution cases thereof, and “m=audio 1234 RTP/AVP 8 0 98” and include it in the new INVITE message of step S1540.

In this case, the step S1550 will increase the likelihood of receiving a “200 OK” reply as shown in FIG. 10. In this way, in step S1560, a multimedia session is established between the sender and receiver 100, 200 thanks to the AI software 1300. Of course, if at the step S1550 another failure reply is received, the AI SDP application (including the AI software 1300) installed on the sender 100 side can generate another new INVITE message according to the first embodiment 1500 and repeatedly retry the session connection.

For reference, RFC-3261 requires that if the original INVITE message is still being processed by the recipient 200, a new INVITE message should not be sent again. RFC-3261 also recommends that RE-INVITE messages not be automatically generated when a conversation is established between the two parties. In the latter case, RFC-3261 states that the reason is to prevent network traffic flooding.

However, for whatever reason, it is not RE-INVITE to perform step S10 of FIG. 40 according to the present invention. This is because step S1540 is executed without a conversation session being established between the sender and receiver 100, 200. Therefore, the INVITE message automatically generated by the step S1540 according to the present invention is not the RE-INVITE.

Furthermore, if step S1540 is executed, the original INVITE message sent by step S1510 is not yet being processed by the recipient 200. In other words, SIP transactions initiated at step S1510 were closed at step S1530. Therefore, the automatic execution of step S1540 according to the present invention is a process that also conforms to the SIP standard.

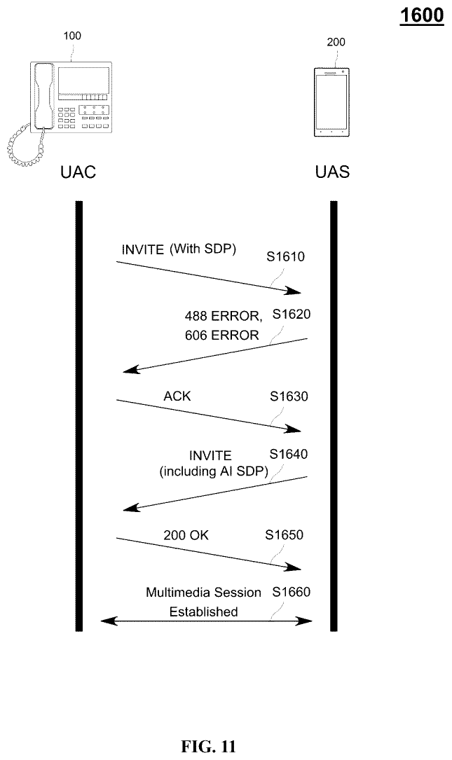

FIG. 11 is a drawing to illustrate a method for compensating for SDP failures using AI based on the second embodiment 1600 of the second aspect according to the present invention.

The SDP failure compensation method 1600 using AI according to the second embodiment of the present invention represents a case in which the AI SDP application (including AI software 1300) installed on the receiver side 200 mainly executes the SDP failure compensation algorithm in comparison to the SDP failure compensation method 1500.

Referring to FIG. 11, in step S1610, UAC 100 generates an INVITE message and sends it to UAS 200. However, in the example of FIG. 11, it is assumed that the SDP message is sent with the early inclusion (i.e., Early Offer) in the INVITE message as shown in FIG. 2B.

If the media description portion of an SDP message sent by the sender 100 in step S1610 is written with a syntax such as “m=audio 1234 RTP/AVP 0 98”, the recipient 200 located in North America is likely to reply to a 488 or 606 message in step S20, which is considered an inappropriate payload type for intercontinental calls. FIG. 11, like FIG. 10, depicts a situation where the session connection fails at step S1620.

In step S1630, UAC 100 sends an ACK message to UAS 200, thus ending the SIP transaction initiated in step S1610.

In the case of the second embodiment of the present invention shown in FIG. 11, the AI SDP application installed on the UAS 200 side performs step S1640.

For example, since the sender 100 is in Korea, the AI SDP application installed on the UAS 200 side predicts that the universal PCMA audio codec will be compatible in this session, and from now on, UAS 200 automatically plays the role of UAC 200, that is, the sender, and transmits the INVITE message to UA 100 in step S1640. It is clear from the previous explanation that the INVITE message in step S1540 is not a NEW INVITE message, nor is it a RE-INVITE message.

As with the step S1540 above, in step S1640, the AI SDP application (i.e., including the AI software 1300) installed on the UA side (i.e., including the AI software 1300) on the UA side (200, which will act as a sender from step S1640 onwards, will be called UA) will initiate a SIP INVITE transaction through step S1640 using the SDP syntax generated by AI, such as “m=audio 1234 RTP/AVP 8 0 98” instead of the “m=audio 1234 RTP/AVP 8 0 98” in the existing SDP message. SIP transactions on step S1640 differ from step S1540 in that the roles of sender and receiver, i.e., UAC and UAS, are reversed.

In this case, step S1650 will increase the likelihood of receiving a “200 OK” reply as shown in FIG. 11. In this way, in the step S1660, a multimedia session is established between the two UAs 200, 100 complemented by the AI software 1300.

Of course, if UA 200 receives a failure reply in step S1650 (e.g., UA 100 does not support codecs such as PT 8 and 0 at all), depending on the cause of the failure, the AI SDP application (including the AI software 1300) installed on the UA 100 can generate another new INVITE message according to this invention. In this case, the AI software 1300 may refer to Tables 2 and 3 to specify a new media type and media format commonly used in Korea and North America, or adjust bandwidth or ports, for example. For example, the AI SDP application (including the AI software 1300) installed on the UA 100 or 200 may suggest a video conference instead of an audio conference in step S1640, or it may automatically download a codec that is commonly compatible between the two UAs 100 and 200 and then try to connect the session again.

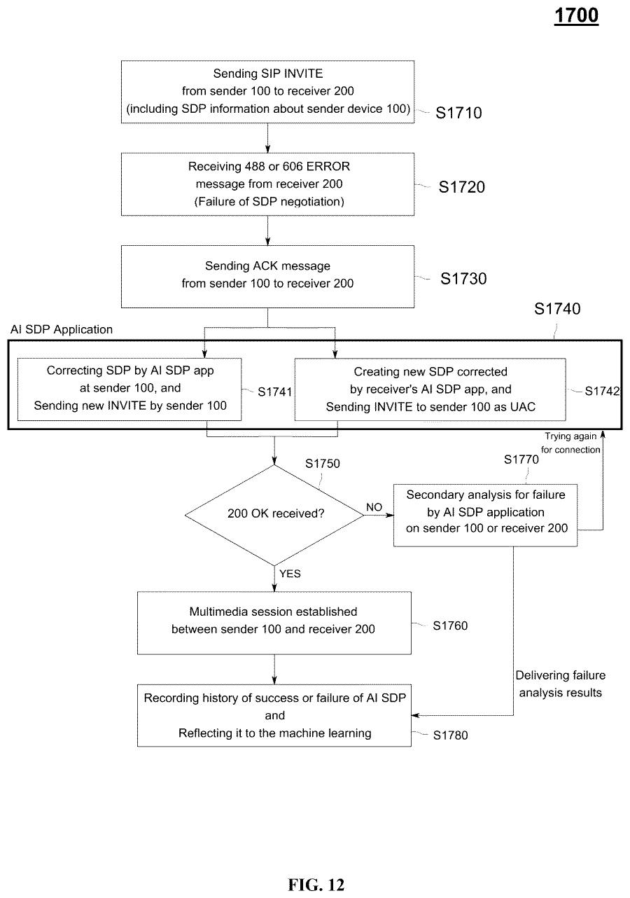

FIG. 12 is an illustrative flowchart comprehensively representing an SDP failure compensation algorithm 1700 using AI based on the first and second embodiments according to the second aspect of the present invention.

In step S1710, the sender 100 sends an INVITE message to the receiver 200 to initiate a SIP transaction, but for the convenience of explanation, the SDP information of the sender 100 is included.

In step S1720, as explained in FIG. 10 and FIG. 11 above, this session connection attempt causes an error such as 488 or 606, and in step S1730, the SIP transaction is terminated by the ACK transmission of the sender 100.

On the step S1740, the AI SDP application works just like the step S1540 or step S1640. In step S1741, the AI software 1300 installed on the sender 100 side will complement the AI SDP, and in step S1742, the receiver 200 will send an INVITE message containing an AI-generated SDP message to UA 100 to act as a UAC.

The step S1750 determines whether the multimedia session between the sender and receiver 100, 200 is successfully connected by the “200 OK” message, and if it is successful, it moves on to the step S1760 to establish a multimedia session between the sender and receiver 100, 200, and data transmission and reception between the two terminals are made possible by methods such as RTP.

If the 200 OK message is not replied this time, the AI SDP application installed on the sender 100 or receiver 200 side in step S1770 will re-analyze the cause of the second failure, and then return to step S1740 to try to complete the AI SDP syntax again.

However, the results of the session connection failure analysis on the step S1770 can be used for AI learning on the step S1780. Of course, the results of successful session connection at the step S1760 can also be used to train AI on the step S1780, so that the AI software 1300 can evolve and the step S1740 can run with a higher session connection success rate in the future.

In summary, the second aspect of the present invention suggests a computer-implemented method to use a session description protocol (SDP) to establish a multimedia session between at least two terminals including a first terminal and a second terminal, comprising: a first step of transmitting to the second terminal a first SDP message including a first session description information about the first terminal to use a predetermined application layer protocol when connecting a session with the second terminal by the first terminal; a second step of receiving a session establishment failure message from the second terminal by the first terminal, based on a session failure ground including an unacceptability of the second terminal with regard to at least one item included in the first session description information; and a third step of transmitting to the second terminal, based on the session failure ground included in the session establishment failure message, a second SDP message created and supplemented with a second session description information addressing the at least one item corresponding to the session failure ground of the first session description information, by a first AI SDP application of the first terminal.

The second aspect of the present invention also suggests another computer-implemented method to use a session description protocol (SDP) to establish a multimedia session between at least two terminals including a first terminal and a second terminal, comprising: a first step of transmitting to the second terminal a first SDP message including a first session description information about the first terminal to use a predetermined application layer protocol when connecting a session with the second terminal by the first terminal; a second step of transmitting a session establishment failure message to the first terminal by the second terminal, based on a session failure ground including an unacceptability of the second terminal with regard to at least one item included in the first session description information; and a third step of transmitting to the first terminal, based on the session failure ground included in the session establishment failure message, a second SDP message created and supplemented with a second session description information addressing the at least one item corresponding to the session failure ground of the first session description information, by a second AI SDP application of the second terminal.

In the computer-implemented method according to the second aspect of the present invention, if the at least one item corresponding to the session failure ground is a media type, the third step may include a process of creating a required media type to establish the multimedia session by a generative AI tool included in the first or second AI SDP application.

In the computer-implemented method according to the second aspect of the present invention, if the at least one item corresponding to the session failure ground is a media format, the third step may include a process of automatically installing a codec supporting the media format corresponding to the session failure ground, on the first terminal or the second terminal, by the first or second AI SDP application.

In the computer-implemented method according to the second aspect of the present invention, if the at least one item corresponding to the session failure ground is a malformed syntax of the first SDP message, the third step includes a process of correcting the malformed syntax by a machine learning tool and a generative AI tool included in the first AI SDP application, according to a syntax construction rule pre-determined in the SDP.

The second aspect of the present invention further suggests a computer system to use a session description protocol (SDP) to establish a multimedia session between at least two terminals, comprising: a first terminal installed with a first AI SDP application; and a second terminal installed with a second AI SDP application and connectable with the first terminal via a network, wherein the first AI SDP application executes processes including (a) a first step of transmitting to the second terminal a first SDP message including a first session description information about the first terminal to use a predetermined application layer protocol when connecting a session between the second terminal and the first terminal; (b) a second step of receiving a session establishment failure message from the second terminal, based on a session failure ground including an unacceptability of the second terminal with regard to at least one item included in the first session description information; (c) a third step of transmitting to the second terminal, based on the session failure ground included in the session establishment failure message, a second SDP message created and supplemented with a second session description information addressing the at least one item corresponding to the session failure ground of the first session description information, on the first terminal; and (d) a fourth step of repeating the third step until the multimedia session between the first terminal and the second terminal is established.

The second aspect of the present invention further suggests another computer system to use a session description protocol (SDP) to establish a multimedia session between at least two terminals, comprising: a first terminal installed with a first AI SDP application; and a second terminal installed with a second AI SDP application and connectable with the first terminal via a network, wherein the first AI SDP application executes a first step of transmitting to the second terminal a first SDP message including a first session description information about the first terminal to use a predetermined application layer protocol when connecting a session between the second terminal and the first terminal, and wherein the second AI SDP application executes processes of a second step of transmitting a session establishment failure message to the first terminal, based on a session failure ground including an unacceptability of the second terminal with regard to at least one item included in the first session description information; a third step of transmitting to the first terminal, based on the session failure ground, a second SDP message created and supplemented with a second session description information addressing the at least one item corresponding to the session failure ground of the first session description information, on the second terminal; and a fourth step of repeating the third step until the multimedia session between the first terminal and the second terminal is established.

In the computer system according to the second aspect of the present invention, if the at least one item corresponding to the session failure ground is a media type, the third step may include a process of creating a required media type to establish the multimedia session by a generative AI tool included in the first or second AI SDP application.

In the computer system according to the second aspect of the present invention, if the at least one item corresponding to the session failure ground is a media format, the third step may include a process of automatically installing a codec supporting the media format corresponding to the session failure ground, on the first terminal or the second terminal, by the first or second AI SDP application.

In the computer system according to the second aspect of the present invention, if the at least one item corresponding to the session failure ground is a malformed syntax of the first SDP message, the third step includes a process of correcting the malformed syntax by a machine learning tool and a generative AI tool included in the first AI SDP application, according to a syntax construction rule pre-determined in the SDP.

### Third Aspect of the Present Invention

The embodiment of the present invention is explained in detail by referring to the attached drawings below.

In order to conduct an online meeting, a session must be created between at least two terminals to participate in the meeting. The SIP standard is a protocol involved in the process of establishing this session, and in order to establish a session, various SIP messages, including INVITE, must be sent and received over the network. There may be separate networks for sending and receiving SIP messages, but at a time when online video conferencing is becoming more common and commonplace, IPv4 or IPv6 networks are considered the most convenient means of using SIP online conferencing systems.

The present invention relates to a method for setting a max-forward value according to the SIP protocol in an IP network. For reference, for the convenience of the present invention, “Max-Forwards”, one of the SIP parameters, is used interchangeably as “Max-Forward”, and the meaning of the two words is treated as the same.

In order to understand the present invention, an understanding of IPv4 and IPv6 systems must first be achieved.

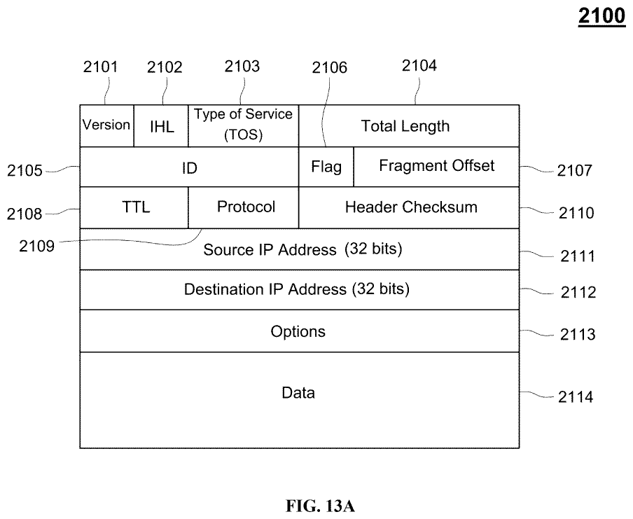

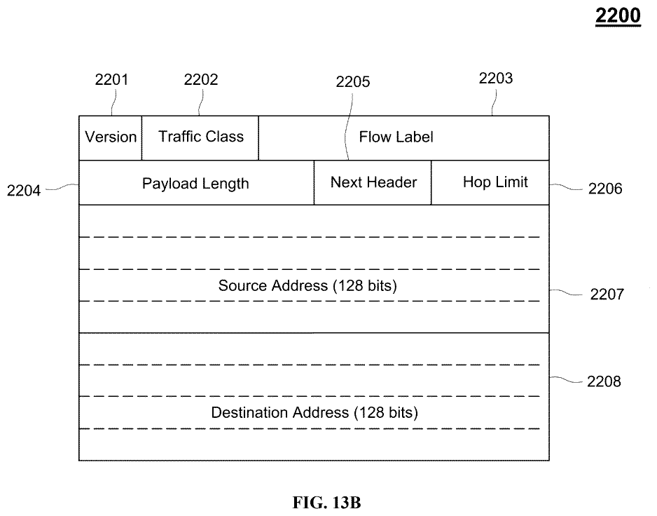

FIG. 13A is a drawing representing the IPv4 (Internet Protocol Version 4) packet structure 2100 of an IP network that can be used for SIP packet transmission with respect to the adjustment of the number of hops according to the third aspect of the present invention. FIG. 13B is a drawing representing the internet Protocol Version 6 (IPv6) packet structure 2200 of an IP network that can be used in SIP packet transmission with respect to the adjustment of the number of hops according to the third aspect of the present invention.

First, referring to FIG. 13A, IPv4 is defined in the Request For Comments-791 (RFC)-791 document (source: https://datatracker.ietf.org/) issued in September 1981 by the de facto international organization for standardization related to Internet technology, called the internet Engineering Task Force (IETF). Since then, IPv4-related matters have been updated through RFC-6864 announced in February 2013.

However, strictly speaking, the IETF was first organized in 1986, and RFC-791 is a U.S. defense standard document submitted by the University of Southern California (USC) to the Defense Advanced Research Projects Agency (DARPA), so it is difficult to say that the IETF directly published the RFC-791 document. However, since RFC documents, which can be said to be de facto Internet standard documents, are currently managed on the website of the IETF organization, for the convenience of explanation, RFC documents managed by the IETF are treated as IETF issued documents regardless of the year of IETF organization. It is also important to note that while it is true that the IETF is a de facto (autonomous) standardization body, the IETF does not have compulsory control over the internet.

Referring to FIG. 13A, an IPv4 packet 2100 or IPv4 datagram 2100 consists of a header, i.e., 13 header fields 2101 to 2113 and a data field 2114. Among these, the Option field 2113 is an optional field with a variable size of a minimum of 0 bytes and a maximum of 40 bytes (Bytes; 1 byte=8 bits), while the remaining fields are mandatory fields that contain the necessary information required for IP packet transmission. Thus, the IPv4 header portion (i.e., 2101 to 2113), excluding the data field 2114, has a standard size of 20 bytes to a maximum of 60 bytes. Optional fields 2113 may include a timestamp (a record of the date and time an event occurred) or security-related matters. As will be discussed later, the present invention proposes that this option field can be used to include parameters related to artificial intelligence, such as AI max-forward and AI TTL according to the present invention.

The Version field 2101 is 4 bits in size and shows the version of the IP protocol used in the packet or datagram. In other words, for the IPv4 packet 2100 shown in FIG. 13A, the version field will be marked with the binary number “02100”, which means “IPv4”. For reference, one bit (Bit, Binary Digital) is the smallest unit of information processed by a computer.

The Header Length field 2102 is also known as the internet Header Length (“IHL”) or HELEN (i.e., short for “Header Length”), and the IHL field 2102 is 4 bits in size. The IHL field 2102 describes the length or size of the IPv4 header. For example, since a standard IPv4 header with the exception of the option field 2113 has a fixed size of 20 bytes, or 160 bits, the IHL field 2102 expressed in 32-bit increments will have the binary number “0101”, which is equivalent to the decimal number 5 (i.e., 5*32=160).

The Type of Service (ToS) field 2103 is 8 bits in size, and it indicates items related to Quality of Service (QoS). QoS can include values related to IP Precedence, which is divided into eight classes, from Class 0 (i.e., “000” in bits) to Class 7 (i.e., “111” in bits), which refers to the importance or priority of packets. In terms of ToS, the first three bits of the above eight bits can indicate IP priority. In addition, the QoS entry may use a Differentiated Services Code Point (DSCP) value, in which case the first 6 bits of the ToS field 2103 are used as the DSCP value. DSCP consists of a total of 64 classes, from Class 0 to Class 63, and is a value used to control network traffic and prioritize packets in consideration of limited network resources, just like the IP priority described above. Packets with low priority may be discarded in some cases due to network resource conditions.

The Total Length field 2104 is 16 bits in size, which defines the total length (i.e., size) of the IPv4 packet 2100, which contains both headers and data. If the data field 2114 is counted, the maximum size of an IPv4 packet 2100 is 65,535 bytes.

The ID (Identification) field 2105 is 16 bits in size and is used to fragment and reassemble packets. In other words, when transmitting packets, packets are sometimes split into smaller units than the size of the original packets, and when the host of the receiving side reassembles the fragmented packets and restores them to the original packets, the ID field 2105 is referenced.

Note that the IPv4 scheme requires all IP hosts to be able to handle at least 1676 bytes of data, and if it needs to handle IPv4 packets 2100 with a greater capacity than one IP host can handle, this ID field 2105 and the fragmentation process are required. The maximum number of datagrams that can be transmitted without fragmentation is called the MTU (Maximum Transmission Unit), and the size of the MTU varies depending on which network is used. For example, for an Ethernet network, the MTU is 1,300 bytes.

The Flags field 2106 is 3 bits in size, meaning that the first bit is always 0 and the first bit itself has no special meaning. If the second bit is 1, it means that the “Don't Fragment; DF)”, and if the second bit is 0, it means that the router can also fragment the packet. If the third bit is 1, then the fragmented current fragment is not the last, but is followed by “There is another fragment following (i.e., More Fragment; MF)”, and if the third bit is 0, it means that the current fragmented fragment is the last fragment.

The Fragment Offset field 2107 is 13 bits in size and indicates where the fragmented packet corresponds to the original packet after the fragmentation process. In other words, the fragmentation offset is used to accurately recombine the fragmented packets.

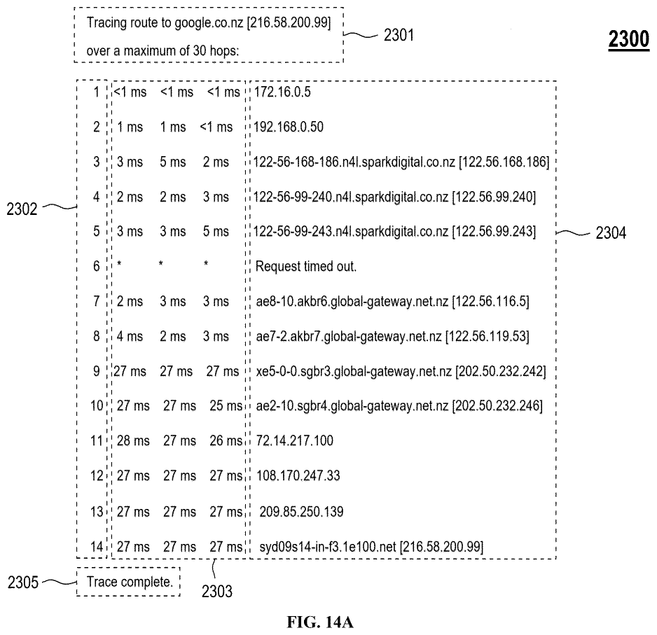

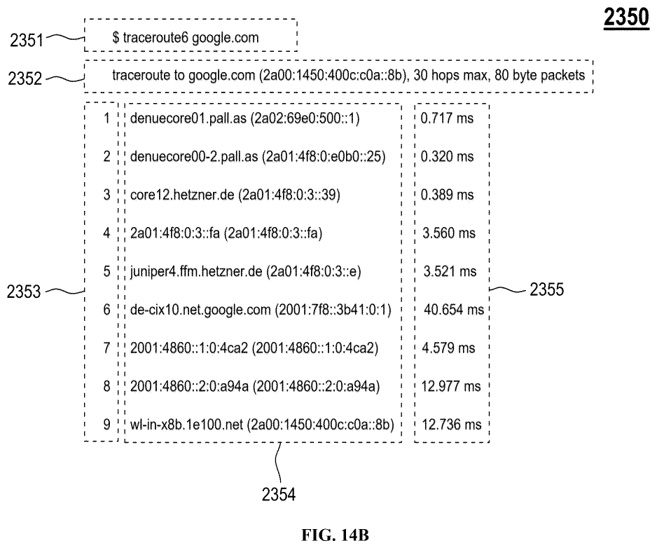

The TTL (Time to Live) field 2108 is 8-bit in size, and is also related to the core of the present invention. In decimal terms, it can be displayed from 0 to 255, and the TTL value is deducted by 1 decimal number each time it passes through the router, and when the TTL value reaches 0, the packet is discarded before it reaches its destination. In other words, the TTL value represents the maximum number of hops (i.e., routers or network segments) that a packet can traverse. The TTL field 2108 is a means to prevent packets from circulating infinitely on the network (also known as packet loops) and to abandon packet transmission after a certain number of hops. The TTL concept will be examined in more detail by referring to FIG. 14A below.

For reference, RFC-3261, which stipulates the SIP standard, requires that when a client sends a REQUEST (request message to a server) to a multicast address, the value of the TTL field 2108 of IPv4 must be set to 1. Multicast is a technology that allows a single message to be sent to multiple recipients, and is used to create a one-to-many or many-to-many SIP communication session. In the case of IPv4, IP addresses “224.0.0.0” to “224.0.0.255” are devoted to support the multicast function, and the multicast IP address for the SIP protocol is “224.0.1.75”. In the case of IPv6, RFC-3261 does not provide otherwise for multicast. In order to understand how to improve the SIP protocol (i.e., adjust the max-forward parameters) according to the present invention, it is necessary to understand RFC-3261 as well, and RFC-3261 is described in detail.

The Protocol field 2109 is 8 bits in size and indicates what protocol was used in the data portion of the packet. In other words, protocols such as TCP (Transmission Control Protocol), UDP (User Datagram Protocol), and ICMP (Internet Control Message Protocol) may be displayed here with respect to the data contained in the data field 2114. The protocol field 2109 is used to inform the router by specifying the Transport Layer Protocol so that the router can properly perform packet transmission behavior.

For reference, ICMP is a message used to convey the diagnosis of the fault when there is a network communication problem. For example, a router at a point where the TTL value is zero earlier drops the packet in transit and sends an ICMP time-exceeded message to the sender. This point will be discussed later with reference to FIG. 14A.

The Header Checksum field 2110 is 16-bit in size and is used to verify the integrity of IPv4 headers, such as checking for duplicate of packets in transit. The router can use the value of this header checksum field 2110 to determine whether a transmission error exists. However, header checksums alone cannot solve all security problems, and various technologies are being developed to encrypt and authenticate IP packets in transit. As mentioned earlier, the option field 2113 can be used to enhance the security of the IPv4 scheme, and is separate from the header checksum field 2110.

Next, the Source IP Address field 2111 is 32 bits in size and contains the IP address of the person who sent the packet, i.e., the origin of the packet. On the other hand, the Destination IP Address field 2112 is 32 bits in size and contains the recipient of the packet, that is, the IP address of the destination of the packet. The source IP address and destination IP address are used by the router to determine the route of packets on the network using the Routing Table, which can be called a map of the network route. Under the IPv4 system, source and destination IP addresses are usually expressed using periods, such as “192.168.1.1” when written as a decimal number. This means that IPv4 addresses are marked with a period “.” It consists of a total of 32 bits, and for convenience, it is common to change the notation in 8-bit units to decimal numbers (i.e., decimal numbers such as 192 and 168) as shown above.

For reference, a public IP address is an address that has a unique value and can be identified by anyone, anywhere in the world. On the other hand, a private IP address does not have a unique value, but is an address that consists of values that can be reused by other private networks on a local basis. A private IP address is one of the addresses pre-assigned for a private IP address, and addresses that fall into the range “10.0.0.0” to “10.255.255.255”, “172.16.0.0” to “172.31.255.255”, “192.168.0.0” to “192.168.255.255”, etc. are generally private IP addresses. Therefore, the “192.168.1.1” example above is likely to be a private IP address.

To add, home routers have a unique public IP address, but they also use a private IP address. NAT (Network Address Translation) is a technology that allows multiple devices in a private network to use a single public IP address, and the NAT router plays a role in changing the source IP address when sending packets, and on the contrary, when traffic comes in, it manages a translation table to send it to the correct private IP address.

Referring to FIG. 13B, the IPv6 packet 2200 shown, which is a new Internet address system proposed by the IETF to overcome the 32-bit address format of IPv4 in FIG. 13A (which is also linked to the total number of IP addresses available). The details of IPv6 are set out in the RFC-82200 document published by the IETF in July 2017. For reference, RFC-82200 replaces RFC-2460 published in December 1998, and RFC-2460 replaces RFC-1883 published in December 1995.

IPv6 represents the IP addresses of the source or destination (i.e., reference numbers 207 and 208, FIG. 14B) in 128 bits, which allows for the use of a large number of additional IP addresses compared to IPv4. To be more precise, this means that up to 2128 Internet addresses (about 3.4*1038) can be created in the IPv6 address system. However, since there are still many devices that still use IPv4, NAT64, one of the NAT technologies described above, was developed to facilitate communication between IPv4 and IPv6 networks. As mentioned earlier, RFC-3261, which specifies the SIP standard, specifies that the SIP protocol supports both IPv4 and IPv6, and the present invention is an invention relating to a method of limiting the number of hops when applying the SIP protocol in an IP network.

Referring to FIG. 13B, the IPv6 headers (i.e., 2201 to 2208) contained in the IPv6 packet 2200 have a fixed size of 40 bytes. This is the difference from IPv4 packets 2100 which have a variable length of 20 to 60 bytes due to the option field 2113 in FIG. 13A.

The version field 2201 in IPv6's header is 4 bits in size and represents the version of the internet protocol applied to the packet, just like IPv4. Thus, in FIG. 13B, IPv6 would be written as a “0110” bit (i.e., a natural number 6 if expressed as a decimal number).

The Traffic Class field 2202 is 8 bits in size, and similar to the ToS field 2103 in IPv4, the first 6 bits of the 8 bits (from left to right in the text) are used to indicate the priority of IPv6 packets. This means that the router can handle traffic according to the priority indicated in the traffic class field 2202. The other two bits are intended for use in the router's ECN (Explicit Congestion Notification) algorithm, for example, “00” indicates that ECN control is not used, and “01” or “10” is used to delay the packet to the receiver by flagging it with CE (Congestion Experienced) without discarding the packet if the router experiences a transmission delay. The latter case is also called ECT (ECN-Capable Transport). In other words, the last two bits contained in the Traffic Class field (202) can be used by the ECN algorithm to ensure that IPv6 packets 2200 are not discarded unconditionally even in the event of a transmission delay.

The Flow Label field 2203 is 20 bits in size and is usually used to transmit non-contiguous IP packets in one continuous stream. Therefore, multiple IPv6 packets 2200 belonging to the same flow will be given the same flow label. The flow label field 2203 is specified by the source, that is, the sender. Thanks to flow labels, routers on the network know that multiple packets belong to the same flow. The flow label field 2203 is usually used for streaming or real-time media transmission.

The Payload Length field 2204 has a 16-bit size. The Payload Length field 2204 tells the router how much data is contained in the payload. The payload (missed) refers to the rest of IPv6 packets 2200 except for the IPv6 header (i.e., 2201 to 2208), which is not shown in FIG. 13B, but the payload again consists of an extension header and an upper layer protocol data unit (PDU).

The extended header has no limit on its size and serves to correspond to the IPv4 option field 2113 mentioned above. In other words, extended headers can be understood as a way to prepare for the more diverse technical requirements on the internet that may exist in the future. On the other hand, the higher-layer PDU contains headers that represent the higher-layer protocols TCP, UDP, ICMP, etc., and their contents, such as TCP/UDP/ICMP messages.

Note that the size of the payload can be up to 65,535 bytes, but if it includes an extended header named “Hop-By-Hop (HBH)”, the payload size can exceed 65,535 bytes, in which case the value of the payload length field 2204 is set to “0”. IPv6 packets 2200 containing payloads larger than 65,535 bytes are called jumbograms, and the maximum length of an IPv6 packet 2200 including jumbograms is about 4.29 billion bytes (4.294967295 gigabytes to be exact).

The Next Header field 2205 is an 8-bit field that displays the type of expansion header described above, or the higher-tier PDU if there is no expansion header. In other words, as mentioned earlier, the higher-layer PDU contains a header representing the higher-layer protocols TCP, UDP, ICMP, etc., and its contents, a message, and each extension header contains its own next header field (undominated). Thus, in an IPv6 packet 2200, the last extended header will represent a higher-level protocol, such as TCP, UDP, etc., and all headers in IPv6, including the extension header, are linked to each other by this next header (i.e., the reference number 2205 and each next header contained in the definite header). If the HBH extension header mentioned above is included, the next header field value pointing to it is set to “0”. Also, if there is no higher-level header that exists after it, the next header contained in the extended header is set to “59”.

The hop limit field 2206 is an 8-bit field of size, and is related to the core of the present invention, just like the TTL field 2108 of IPv4 earlier. The hop limit, like TTL, is deducted by 1 decimal number each time it goes through the router (e.g., if it is set to a maximum of 30 hops, 29, 28, 27, . . . . The hop limit value is subtracted), and when it reaches 0, the packet is discarded before it reaches its destination. In the IPv6 system, as in IPv4, a parameter called hop limit was introduced as a means to prevent packet loops.

The Source Address field 2207 and the Destination Address field 2208 each have a size of 128 bits, which represents the IPv6 addresses of the sender and receiver of the packet, respectively. For example, Google©'s public DNS (Domain Name System) IP address is “8.8.8.8” for IPv4 as shown in FIG. 13A, while for IPv6 in FIG. 13B, the IP address notation rules are different, such as “22001:4860:4860::8888” or “22001:4860:4860:0:0:0:0:8888” in IPv6, which is the same as FIG. 13B.

FIG. 14A is a drawing that illustrates the results of an exemplary search for the routing path of an IPv4 packet according to the third aspect of the present invention. FIG. 14B shows the results of an exemplary search for the routing path of an IPv6 packet according to the third aspect of the present invention.

In other words, FIG. 14A shows the result of exemplifying the routing path of the IPv4 packet 2100 examined in FIG. 13A, and FIG. 14B shows the result of exemplifying the routing route of the IPv6 packet 2200. Both FIG. 14A and FIG. 14B are intended to assist in the technical implications of the TTL field 2108 and hop limit field 2206 described above, with respect to the adjustment of the number of hops by AI, which is the core of the present invention.

First, referring to FIG. 14A, the route search results 2300 of IPv4 addresses using the “traceroute” command, which is a typical routing route search method, are shown. “traceroute” can be used to run a packet transmission path tracing, for example, on a Windows™ operating system (OS), by opening a command prompt window, typing the command “tracert”, followed by an IPv4 format destination address.

FIG. 14A is an exemplary result of executing this “tracert” command, the source of which is “https://support.n4l.co.nz/s/article/”. In the example of FIG. 14A, the IPv4 address “216.58.2200.99” used by Google in New Zealand is set as the test destination, and the origin information is unknown. However, the origin information itself is not important in the explanation of FIG. 14A.

Referring to FIG. 14A, when executing the “tracert” command, a command execution message 2301 is output, for example, “We will send a test ICMP packet over up to 30 hops to explore the routing route” as in FIG. 14A.

After that, some time has passed, as shown in reference number 2302, “1, 2, 3, . . . .” In this way, the hops through which the ICMP packet (for routing purposes) pass through are output in order, and each order contains the RESPONSE of each router to the test ICMP REQUEST packet. Although not shown in FIG. 14A, if the route search fails, the hop order 2302 is indicated, for example, up to 30, in the same format as the 6th hop in FIG. 14A, a message indicating that the router has failed to receive a response from a certain hop point to the 30th hop (i.e., “Request Timed Out” in FIG. 14A) is continuously output and the route tracing is terminated.

In FIG. 14A, the reference number 2303 indicates the response time of the router. When “traceroute” is run, the origin terminal sends a total of three test ICMP packets to the destination terminal, for example, the 11th hop shows “28 ms, 27 ms, 26 ms”, which indicates the response time of each of these three packets in ms. For example, if we look at the 12th hop of the router response time 2303, it can be seen that all three ICMP packets have the same response time of 27 ms, and the response time may vary slightly each time an ICMP packet is sent, such as the 11th hop. Overall, like the 14th hop, the response time generally slows down as getting closer to the destination, as can be seen in the example of FIG. 14A. However, it is difficult to conclude that this phenomenon is inevitable.

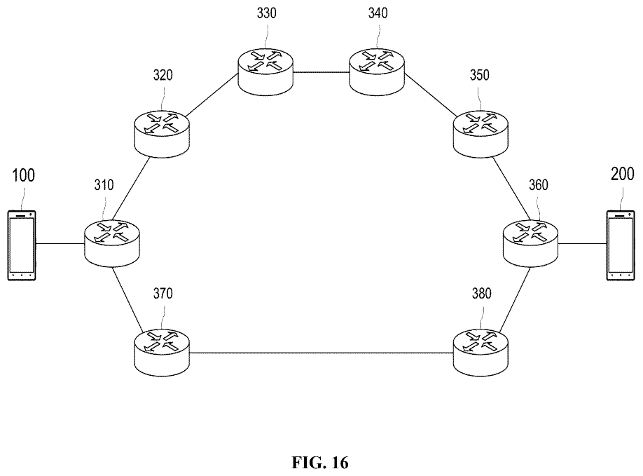

In addition, not all three test ICMP packets need to be sent over the same network path (this is discussed later in FIG. 16), and sometimes even one hop may contain more than one different router address (missed). Also, if the sender tested in FIG. 14A is located in Asia or the European continent, for example, the router located on the undersea cable connecting the continents may be indicated among the hops.

For reference, in the case of the sixth hop of the router response time 2303 in FIG. 14A, all three response times are marked with “*”, and the reference number 2304 entry that indicates the router IP address of the hop has the mark “Request Timed Out”. This usually means that there is a problem on the path on which packets are sent to the destination, or that there is no suitable route to the destination. However, in the example of FIG. 14A, it sent a normal response again from hop 7, and since the packet reached its destination on hop 14 (i.e., see message No. 155 indicating that the route trace was complete), it is likely that only the router on hop 6 simply did not respond to the ICMP packet. In other words, according to the example in FIG. 14A, it can be seen that despite the error of the sixth hop, there is a normal packet transmission path from origin to destination.

When looking at the hop address 2304 part of FIG. 14A, it can be seen that there are many hops that are displayed in the form of an Internet domain (co.nz or an address ending in net.nz, etc.), as well as the IPv4 address of each router from the third hop. Although the geographic location of the router cannot be accurately determined by these Internet domain designations alone, it is possible to infer the location approximately. For example, the “n4l” common to hops 3-5 may represent “Network for Learning”, a public organization that provides a secure digital environment for New Zealand schools and other facilities, so assuming that the route test in FIG. 14A was conducted in a country other than New Zealand, it can be assumed that ICMP packets reached New Zealand territory from at least the first hop. In addition, many companies use the three-symbol airport code (Airport Code) used by the International Air Transport Association (IATA) to address their routers, so if the hop has a domain notation that includes the airport code when running “traceroute”, the location of the hop can be roughly estimated based on the actual airport location.

Also, although it is not shown in FIG. 14A, if the command “ping” is used in addition to “traceroute”, it may be checked regarding whether there is a connection between the two hosts. However, when “ping” is run, detailed information for each hop is not displayed as shown in FIG. 14A.

If the “traceroute” command cannot find a route to a destination, the hop order 2302 must wait until the specified hop limit is reached to see the final result of the route trace. For example, if the TTL or hop limit parameter value shown in FIG. 13A or FIG. 13B is set to 70, the “Trace Complete” message 2305 will be output only after seeing the error message “Request Timed Out” until the hop order 2302 reaches 70. Waiting for an error message to be printed up to the 70th time can take a considerable amount of time.

Next, in the case of FIG. 14B, an illustrative result 2350 of tracing a routing route using the “traceroute” command in the IPv6 address system is shown. The source of the example shown in FIG. 14B is “https://pall.as/ipv6-on-mac/”, and this time an example of tracking the IPv6 address of the website “google.com”, which is a test destination on MAC® OS, is shown. Even in the example of FIG. 14B, the information of the origin is not known, but this is an unimportant part of the description of the present invention.

FIG. 14B shows that the ICMP packet (for routing tracing) traveled a total of 9 hops from the origin to the IPv6 address “2a00:1450:200c:c0a::8b” of the destination google.com®. When entering a destination address in the Network Utility entry on MAC OS, the route tracing command 2351 is displayed, and the IPv6 tracing command uses “traceroute6” with the number “6” added to the command.

For reference, in FIG. 14B, it can be seen that the DNS name “google.com” was used directly instead of the IPv6 address after the “traceroute6” command, and in the example of FIG. 14B, the “traceroute6” command works correctly even in this case. However, it should be noted that when using a DNS name instead of an IPv6 address after the “traceroute6” command, the route tracing may not run properly.

The route search result 2350 includes a command execution message 2352 as in FIG. 14A, and it can be confirmed that the MAC™ OS also performs route tracing of up to 30 hops for IPv6 through the command execution message 2352.

According to the hop order 2353 in FIG. 14B, it can be seen that the packet reached its destination via a total of 9 hops in the example given in FIG. 14B. The address of each hop through which the test packet passed can be found by referring to the hop address 2354, and the response time of each hop can be found by checking the router response time 2355 mark. As in the case of FIG. 14A, in the example of FIG. 14B, we can see that the response time increases as we get closer to the destination. However, in the example of FIG. 14B, the largest delay of 40.654 ms occurred on the 6th hop.

On the other hand, the hop address 2354 shows the IPv6 address of each router, and in some cases, a specific domain name, such as the “core12.hetzner.de” on the third hop, may be represented with the IPv6 address. For reference, Hetzner® is one of the largest data center operators in Europe, and similar to FIG. 14A, the third hop is probably the router in Germany among the routers it operates. The “.as” address notation in the first and second of the hop order 2353 corresponds to the Country Code Top-Level Domain (ccTLD) of American Samoa, Oceania.

By reviewing FIGS. 13A to 14B, IPv4 and IPv6 schemes can be understood together with the technical meaning for packets to pass through “hops.”

The most important point in FIG. 13A to FIG. 14B with respect to the third aspect of the present invention is that if the number specified in the TTL field 2108 or the hop limit field 2206 is too small (e.g., 2 or 3), the packet 2100, 2200 may not reach its destination and may be discarded, as in FIG. 14A or FIG. 14B. On the other hand, it is worth noting that if the number specified in the TTL field 2108 or hop limit field 2206 is too large, the packet 2100, 2200 may not only make too many attempts to find the route, which can put a strain on the network, but also sometimes give a third party with the intended hacking intent more opportunities or time to intercept packets 2100, 2200 before they have been dropped, which can pose a security risk.

The concept is virtually the same as TTL field 2108 or hop limit field 2206 in the SIP protocol, and the present invention is intended to deal with the problem of setting the max-forward parameter too small or too large. For reference, the SIP standard protocol used for video conferencing, etc., sets the default to 70 the maximum number of hops that a packet can pass through, and the main purpose of the present invention is to improve this.

FIGS. 13A to 14B should have given some understanding of why the number of 70 default hops needed to be adjusted.

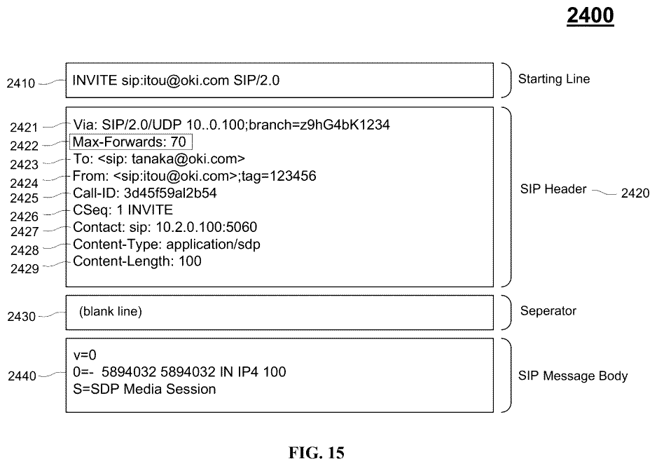

FIG. 15 is an illustrative drawing illustrating the structure of a SIP message (2300) including a SIP header in which an adjustment of the number of hops according to the present invention can be made.

FIG. 15 is an illustrative drawing showing a message structure 2400 including the SIP header 2420 in which the number of hops can be adjusted according to the third aspect of the present invention.

First, the starting line 2410 contains a request such as INVITE. In RFC-3261, the phrase INVITE is also referred to as a Method Name. The SIP URL that follows the INVITE phrase is the SIP URL, and in the example of FIG. 15, it represents the other participant that may join the meeting.

Next, the Via field 2421 contains the branch parameters that specify the transaction, as seen earlier, and in the example of FIG. 15, the object to which the sender 100 wants to receive a reply, that is, the recipient 200, is specified in the via field.

The To field 2423 contains the user's display name of the recipient 200, and the destination of the INVITE message is displayed.

The From field 2424 contains the user display name of the sender 200 and contains the relevant SIP URL. When using a softphone, an arbitrary string of characters is attached to the from field as a tag parameter.

The Call-ID field 2425 contains an identifier that uniquely identifies the message, which is a combination of an arbitrary string and the softphone's host name or IP address. Therefore, the combination of the two-field, from-field, and Call-ID fields makes this peer-to-peer SIP connection completely specific.

The CSeq or Command Sequence field 2426 contains the integer (i.e., “1”) and method (in this case, “INVITE”) names. The CSeq number is configured in such a way that each new request is added in this conversation, and the serial number will be incremented by one.

The Contact field 2427 contains the user name or IP address, which contains the SIP URI to contact the sender. If the via is used to tell where to send the response, the Contact field can be understood as telling where to send the request if there is a future request.

The Content-Type field 2428 contains a description of the message body 2440.

The Content-Length field 2429 displays the number of bytes in the message body 2440.

Since the spaced space 2430 and the message body 2440 are irrelevant to the core of the present invention, the detailed description of these components is omitted in the present specification.

On the other hand, the max-forwards field of the SIP protocol, which is the most important in the present invention, defines the maximum number of hops that can be used for a request to reach its destination. As for what the maximum number of hops means, we have looked at it in FIGS. 13A to 14B. The max-forwards field 2422) is specified as an integer value, and like TTL 2108 or hop limit 2206, SIP messages are deducted by 1 for each time they pass through the router. Currently, it is recommended in RFC-3261 that the max-forwards field 2422 should be set to 70 by default unless other circumstances are possible. For reference, to explain the concept of hop-count again, hop count refers to how many routers a packet sent over the internet passes through from the origin (that is, the source) to the destination. In other words, in the present invention, the number of routers through which the packet passes will be equal to the hop count.

FIG. 16 is a drawing illustratively representing an IP-based SIP network to illustrate the way in which the number of hops is adjusted by AI according to the third aspect of the present invention.

In other words, FIG. 16 is a drawing to explain that even if the sender 100 and receiver 200 are the same, the number of hops before the packet reaches its destination may vary depending on the case. In addition, the AI software 1300 according to the present invention is configured to calculate the number of hops actually required for the establishment of a SIP session between two terminals (i.e., reference numbers 100 and 200 in FIG. 16) at regular intervals through the periodic automatic execution of instructions (e.g., “traceroute”) such as FIG. 14A and FIG. 14B, which are previously discussed.

IP routing, as described in FIG. 16, refers to the process of determining the path required to transmit packets from a source to a destination on an IPv4 or IPv6 network of an IP network. Each router stores algorithms and routing tables that help to find the most efficient route for sending IP packets. However, since the logic for setting the routing route is diverse, and the core of the present invention does not change depending on what the logic is, the explanation of the setting algorithm of the routing route is omitted in the present invention.

For reference, in FIG. 16, it is assumed that both the sender 100 and the receiver 200 are terminals with a unique public IP address, for example. In the case of Windows OS, if use the command “route print” is used, it is possible to check the route determined by the routing process above.

In FIG. 16, if the packet sent by the sender 100 reaches the first router 310, the first router 310 opens the received packet and finds the destination IP address contained in it, which is used to determine the route. The first router 310 also uses the routing table to determine whether there is a route to the destination.

For example, in FIG. 16, it is clear that the router reference number 310-370-380-360, and the first route leading to the receiver 200 is the shortest route. However, if the latency of this first route is high one day, the second route may be selected, for example, the router reference number 310-320-330-340-350-360-recipient 200. Again, There are various algorithms and variables for which routing path the router 310 to 380 chooses, but the method of setting the routing path is irrelevant to the core of the present invention, so further explanation will be omitted here.

Rather, it is important to note that in the case of the present invention, even if the same sender 100 and receiver 200 are located, the number of routers transited during packet transmission may be different even if the same origin and destination are the same depending on the situation or according to the passage of time.

The present invention proposes to be equipped with an artificial intelligence application (e.g., consisting of AI software 1300 such as FIG. 8) that is linked to the core configuration of the sender 100. Considering that the SIP protocol supports the IPv4 or IPv6 protocol, and that the IPv4 or IPv6 network is the most widely used network at present, the present invention mounts an artificial intelligence application on the terminal 100 of the sender's side, for example, and then periodically (e.g., several hours, days, days, months, years, etc.) tracks the number of hops required for packet transmission between the sender 100 and the receiver 200. Of course, this hop count tracking is not only done for one recipient 200. Since a SIP conference session can also be established between the sender 100 and another recipient located in a different region or country, when the sender 100 creates a SIP session with another terminal, the AI algorithm will similarly perform periodic hop count tracking to that destination.

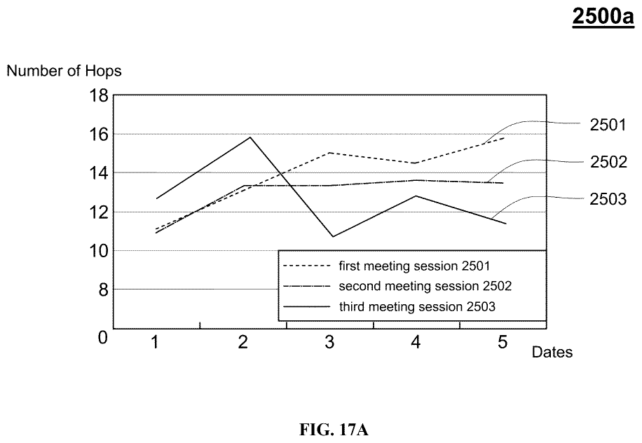

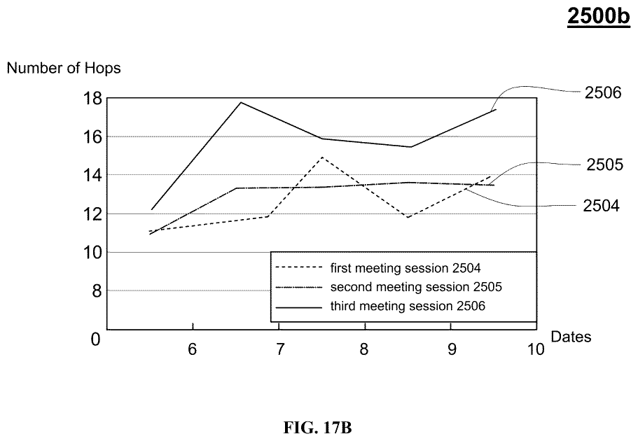

FIG. 17A and FIG. 17B are graphs that illustrate the results 2500a, 2500b of periodic measurement of the number of hops required by the sender terminal 100 to transmit packets to the destination 200 in order to adjust the number of hops by AI according to the third aspect of the present invention.

Referring to FIG. 17A, the session held between the transmitting terminal 100 located in Korea and the first receiver terminal located in the United States from the 1st to the 5th of a certain month of a certain year is exemplified as “the first meeting session 2501”. As shown in FIG. 17A, it can be seen that the number of hops required for the first session 2501 connection varies from 11 to 16 depending on the date. (i.e., 9, 13, 15, 15, 16, etc., with an average of 13.6 per day)

Similarly, for example, if a session between a transmitting terminal 100 located in Korea and a second receiver terminal located in Japan is defined as “Session 2 2502”, it can be seen that the session of the second session 2502 is operated stably via approximately 13 hops. (i.e., 9, 13, 13, 13, 13, 13, daily average 12.2)

Finally, for example, if the session between the transmitting terminal 100 located in Korea and the third receiver terminal located in Russia is defined as “the third session 2503”, it can be seen that the hop variation by date is large for the third session, such as 13, 16, 11, 13, 11, etc. (i.e. 12.8 per day average)

According to the present invention, if the AI software 1300 installed on the sender terminal 100 sets a preset adjustment value of +/−5 for the first session 2501, and adds or subtracts from the average number of hops for a specific period obtained earlier, the range of 9.6˜18.6 is calculated from the average value of 13.6 individuals. Accordingly, for example, for the first session 2501, the present invention can operate a conference session from the sixth day onwards between the sender terminal 100 and the first receiver terminal located in the United States by setting 19, which is an integer rounded to 18.6, as the AI max-forwards parameter (instead of 70).

In a similar way to the above, for example, for the second session 2502, the adjustment value can be set to 1, and the max-forwards parameter value can be set to 13 (i.e., an integer rounded to 13.2) based on the 11.2˜13.2 range obtained according to the adjustment value. Then, from Day 6, instead of the default value of “70”, sessions between the sender terminal 100 located in Korea and the second receiver terminal located in Japan may be managed based on the AI max-forward parameter of 13.

For example, for the third session 2503, set the adjustment value can be set to 4, and from day 6, the AI max-forward parameter of 17 can be used.

However, the max-forward value generated by the present invention is an “AI max-forward” value, and it is necessary to understand it as a slightly different concept from the existing SIP max-forward parameters. The present invention does not use the default max-forward value of 70 set by the SIP standard, but uses a new max-forward value set by the AI software 1300 according to the logic illustrated above. In the present invention, it is to be named “AI Max-Forward” for convenience.

The max-forward parameters can be adjusted using KAMAILIO®, CLI (Command-Line Interface), web interface (e.g., Chrome® browser), etc., and the AI software 1300 uses such a max-forward parameter adjustment tool as exemplified in FIG. 17A. In other words, the number of hops is tracked and recorded for a certain period of time for each of the origin-destination segments, for example, for each previous session from the 1st to the 3rd session, the average value is obtained, and then the AI max-forward value is determined by the AI software 1300 by introducing an appropriate adjustment value for each origin-destination pair, and it is used as the max-forward parameter value to be used in the actual meeting with KAMAILIO®, CLI (Command-Line Interface), Web Interface (e.g., Chrome® browser), etc.

However, according to the results 2500b of the other date intervals shown in FIG. 17B, it can be seen that the number of hops in each of the first and third sessions 2504, 2505, 2506 differed from the follow-up results for the last five days (i.e., FIG. 17A).

In particular, in the case of the third session 2506 from Day 6 to Day 10, assuming that the “third session 2503” between the sender terminal 100 located in Korea and the third receiver terminal located in Russia was operated based on the AI max-forward parameter “17,” it can be assumed that the conference session could not be connected at least twice due to insufficient AI max-forward value.

The present invention is capable of running an AI algorithm that significantly increases the adjustment value for this session from 4 to 8, for example, considering that the hop fluctuation of the third session 2503 was large, for example, if the case where the AI max-forward value is found to be insufficient exceeds a predetermined threshold (e.g., once in 5 days, once in a year, 2 or more times in 5 days, etc.).

In this case, starting on Day 11, for the third session 2503, for example, the total average of hops from Day 1 to Day 10 (i.e., 13, 16, 11, 13, 11, 12, 18, 16, 16, 17, 14.4 on the 10th day) plus the changed adjustment value 8) can be set to the new AI max-forward value and operated from Day 11. However, if the AI max-forward value has never exceeded 23 after the 11th day of the third session 2503, for example, during a one-year period, the AI max-forward value can be set to 20 by deducting 3, for example, and it will be possible to operate it from next year.

If the AI max-forward value is adjusted too frequently in the same way as above (e.g., if the AI max-forward adjustment is considered “too frequent” if it is adjusted more than once a week), it would be reasonable to consider upgrading even the changed adjustment of 8 by a larger margin, or setting the hop tracking cycle itself to be a month longer than the average value of the 5-10-day interval.

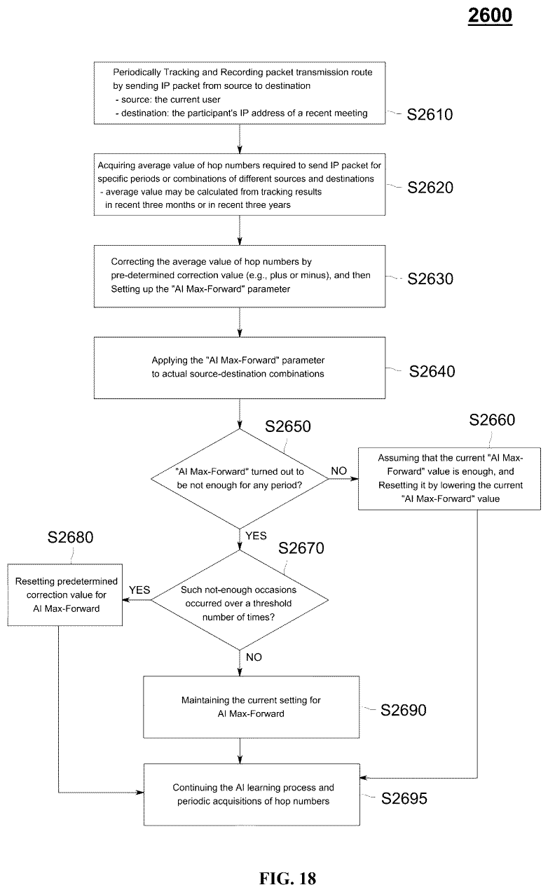

FIG. 18 is a flowchart representing an AI-based max-forward setting algorithm for upgrading max-forward parameters for the improvement of the SIP standard protocol in an IP network according to the third aspect of the present invention.

FIG. 18 is a flowchart representing an AI-based max-forward configuration algorithm 2600 that sets max-forward parameters for the improvement of SIP standard protocols in IP networks pursuant to the present invention.

In step S2610, using IP packets, the “traceroute” command is executed by the AI software 1300 installed on the sender terminal 100 at a predetermined interval in the origin-destination pair, defined as the first to third session, as shown in FIG. 17A to 17B, and the result is recorded. Here, the destination could be the IP address of the other party who has had a meeting in the last year, for example, and in this case, it might be needed to define between 50 and 2100 meeting sessions, for example. The tracking period for the number of hops can be set in various ways, such as 5 days, 10 days, one month, and 1 year.

The step S2620 calculates the average value of the number of hops for each segment and for each conference session with each origin-destination pair.

The step S2630 then defines a new parameter called “AI max-forward” by means of a preset calibration value (e.g., for the third session, a correction value of “4” was obtained based on the first 5 days).

In the step S2640, the AI software 1300 uses KAMAILIO® and other tools to run the meeting session with the “AI max-forward” value obtained from the step S2630.

The step S2650 tracks cases where the meeting did not go through due to insufficient “AI max-forward” value, but if there were no such cases for a certain amount of time, the step S2660 can reduce the AI max-forward value by resetting the deduction mentioned above.

If the “AI max-forward” value is insufficient in step S2650 more frequently than a predetermined threshold, the step S2670's decision will be YES, and the AI software 1300 can therefore move on to step S2680 and take steps such as increasing the adjustment value from 4 to 8 for example, or changing the settings to track the number of hops over a longer period of time to increase the reliability of the averaging measurement interval.

Of course, if the judgment on the step S2650 shows that the current “AI max-forward” value is considered stable, then we can move on to the step S2690 and maintain the current “AI max-forward” value.

Regardless of whether the step S2660, S2680 or S2690 is used, the AI software 1300 can learn and evaluate the logic for determining the “AI max-forward” value, fine-tune the specific threshold values or intervals of the “AI max-forward” setting according to the present invention, and then re-perform the process from step S2695 onwards.

In summary, the third aspect of the present invention suggests a computer-implemented method to execute a session initiation protocol (SIP) to establish a multimedia session between at least two terminals including a sender terminal and a receiver terminal, comprising: performing a periodic tracking on a number of hops required to transmit an IPv4 or IPv6 packet from the sender terminal to the receiver terminal, by an AI SIP application installed with the sender terminal; acquiring a mean value over an interval per a predetermined unit period based on the number of hops periodically tracked, by the AI SIP application; continuing the periodic tracking by setting an AI max-forward parameter as a result of addition or subtraction of a predetermined natural number to the mean value over the interval when executing the SIP on the sender terminal by the AI SIP application; counting a number of occasions where the AI max-forward parameter turns out not to be enough during the periodic tracking, by the AI SIP application; and adjusting the AI max-forward parameter with a predetermined incremental value if the counted number of the occasions reaches a threshold level, by the AI SIP application, or adjusting the AI max-forward parameter with a predetermined decremental value if the counted number of the occasions does not reach the threshold level for a predetermined amount of term while performing the periodic tracking.

In case of the computer-implemented method according to the third aspect of the present invention, if the adjusting of the AI max-forward parameter occurs over a predetermined frequency, then the incremental value or the decremental value may be replaced by an adjusted incremental value or an adjusted decremental value.

In case of the computer-implemented method according to the third aspect of the present invention, if the adjusting of the AI max-forward parameter occurs over a predetermined frequency, then the periodic tracking may be adjusted to be performed less frequently or more frequently than before.

In case of the computer-implemented method according to the third aspect of the present invention, the AI SIP application may create an indication that a max-forward parameter used in the SIP is substituted with the AI max-forward parameter as a field value of an IPv4 packet header, an IPv6 packet header, or an SIP message header.

The third aspect of the present invention also suggests a computer network system to execute a session initiation protocol (SIP) to establish a multimedia session between at least two terminals, comprising: a sender terminal transmitting an INVITE message based on the SIP; and a receiver terminal receiving and replying to the INVITE message based on the SIP, wherein the sender terminal is installed with an AI SIP application, and wherein the AI SIP application executes processes of (a) performing a periodic tracking on a number of hops required to transmit an IPv4 or IPv6 packet from the sender terminal to the receiver terminal; (b) acquiring a mean value over an interval per a predetermined unit period based on the number of hops periodically tracked; (c) continuing the periodic tracking by setting an AI max-forward parameter as a result of addition or subtraction of a predetermined natural number to the mean value over the interval when executing the SIP on the sender terminal; (d) counting a number of occasions where the AI max-forward parameter turns out not to be enough during the periodic tracking; and (e) adjusting the AI max-forward parameter with a predetermined incremental value if the counted number of the occasions reaches a threshold level, by the AI SIP application, or adjusting the AI max-forward parameter with a predetermined decremental value if the counted number of the occasions does not reach the threshold level for a predetermined amount of term while performing the periodic tracking.

As for the computer network system according to the third aspect of the present invention, if the adjusting of the AI max-forward parameter occurs over a predetermined frequency, then the incremental value or the decremental value may be replaced by an adjusted incremental value or an adjusted decremental value.

As for the computer network system according to the third aspect of the present invention, if the adjusting of the AI max-forward parameter occurs over a predetermined frequency, then the periodic tracking may be adjusted to be performed less frequently or more frequently than before.

As for the computer network system according to the third aspect of the present invention, the AI SIP application may create an indication that a max-forward parameter used in the SIP is substituted with the AI max-forward parameter as a field value of an IPv4 packet header, an IPv6 packet header, or an SIP message header.

Although the meeting security method and system according to the present invention are described in detail with reference to the above attached drawings, the functions mentioned in the present invention can be implemented in various digital electrical circuits, and in the case of software, it can be implemented in various ways, such as firmware, hardware, and applications, which can be regarded as the same or equivalent to the process initiated in the present invention.

In the present invention, “Module” may mean one or more program sets consisting of computer program instructions or scripts, and may sometimes be in the form of an execution file in which the source code is compiled for the purpose of manipulating a hardware processing device or controlling data and information. Furthermore, a program instruction written pursuant to the present invention may be included in an encoded signal for information transmission, which may be transmitted and received between devices and may induce mutual cooperation between multiple devices.

It should be noted that the computer program implemented under the present invention may be implemented as a program that operates in parallel and cooperatively in a plurality of places connected by a communication network, and that not only a computer program running in a single place physically can implement the function of the present invention.

The “processing device” referred to in the present invention may include FPGA (Field Programmable Gate Array), ASIC (Application-Specific Integrated Circuit), etc., and sometimes it can be implemented as a protocol stack, database management system, operating system, virtual machine, or a combination thereof.

For the purposes of the present invention, “memory” means all computer storage media, which may be a random or serial access memory device that can be read by a computer, and may include a medium such as a disk that physically stores the above computer program. Accordingly, in the present invention, the memory may be composed of EPROM (Erasable Programmable Read Only Memory), EEPROM (Electrically Erasable Programmable Read Only Memory), DVD (Digital Video Disk), RAM (Random Access Memory), or a combination thereof, and the memory or storage space based on the cloud service may also correspond to the memory of the present invention.

For the purposes of the present invention, “database (DB)” means a structure in which information or data stored electromagnetically in a computer system is combined. Databases are usually controlled by DBMS (Database Management System), and DB applications and DBMS can be called DB systems or simply databases.

For the purposes of the present invention, “server” means a computer device that provides resources such as multimedia on a network, and in fact, a server can be implemented in two forms: hardware or software. A hardware server is a physical device connected to a computer network, and any computer can function as a server or host if it is equipped with server software. A software server is a computer program that provides specific services for client programs over a network or locally. For reference, in the present invention, “proxy server” means a computer system or application that relays to enable a client to indirectly access a specific network service.

Finally, for the purposes of the present invention, “protocol” means the rules that define the mode of exchange of data inside a computer or between computer devices. It can be compared to a common language used by different computers. The official language of the World Wide Web (WWW) Internet can be said to be HTTP (Hypertext Transfer Protocol), and HTTPS (HTTP Secure), which enhances the security function by encrypting HTTP messages, is also one of the representative communication protocols that can be applied when constructing a meeting security network according to the present invention.

In light of the foregoing, the present invention should be understood to include such a simple design modification if it is obvious to the contractor, and the present invention should be limited only by the attached claims.

What is claimed is:

1. A computer-implemented method to execute a session initiation protocol (SIP) to establish a multimedia session between at least two terminals including a sender terminal and a receiver terminal, comprising:
performing a periodic tracking on a number of hops required to transmit an IPv4 or IPv6 packet from the sender terminal to the receiver terminal, by an AI SIP application installed with the sender terminal;
acquiring a mean value over an interval per a predetermined unit period based on the number of hops periodically tracked, by the AI SIP application;
continuing the periodic tracking by setting an AI max-forward parameter as a result of addition or subtraction of a predetermined natural number to the mean value over the interval when executing the SIP on the sender terminal by the AI SIP application;
counting a number of occasions where the AI max-forward parameter turns out not to be enough during the periodic tracking, by the AI SIP application; and
adjusting the AI max-forward parameter with a predetermined incremental value if the counted number of the occasions reaches a threshold level, by the AI SIP application, or adjusting the AI max-forward parameter with a predetermined decremental value if the counted number of the occasions does not reach the threshold level for a predetermined amount of term while performing the periodic tracking.

2. The computer-implemented method of claim 1, wherein, if the adjusting of the AI max-forward parameter occurs over a predetermined frequency, then the incremental value or the decremental value is replaced by an adjusted incremental value or an adjusted decremental value.

3. The computer-implemented method of claim 1, wherein, if the adjusting of the AI max-forward parameter occurs over a predetermined frequency, then the periodic tracking is adjusted to be performed less frequently or more frequently than before.

4. The computer-implemented method of claim 1, wherein, the AI SIP application creates an indication that a max-forward parameter used in the SIP is substituted with the AI max-forward parameter as a field value of an IPv4 packet header, an IPv6 packet header, or an SIP message header.

5. A computer network system to execute a session initiation protocol (SIP) to establish a multimedia session between at least two terminals, comprising:
a sender terminal transmitting an INVITE message based on the SIP; and
a receiver terminal receiving and replying to the INVITE message based on the SIP,
wherein the sender terminal is installed with an AI SIP application, and
wherein the AI SIP application executes processes of (a) performing a periodic tracking on a number of hops required to transmit an IPv4 or IPv6 packet from the sender terminal to the receiver terminal; (b) acquiring a mean value over an interval per a predetermined unit period based on the number of hops periodically tracked; (c) continuing the periodic tracking by setting an AI max-forward parameter as a result of addition or subtraction of a predetermined natural number to the mean value over the interval when executing the SIP on the sender terminal; (d) counting a number of occasions where the AI max-forward parameter turns out not to be enough during the periodic tracking; and (e) adjusting the AI max-forward parameter with a predetermined incremental value if the counted number of the occasions reaches a threshold level, by the AI SIP application, or adjusting the AI max-forward parameter with a predetermined decremental value if the counted number of the occasions does not reach the threshold level for a predetermined amount of term while performing the periodic tracking.

6. The computer network system of claim 5, wherein, if the adjusting of the AI max-forward parameter occurs over a predetermined frequency, then the incremental value or the decremental value is replaced by an adjusted incremental value or an adjusted decremental value.

7. The computer network system of claim 5, wherein, if the adjusting of the AI max-forward parameter occurs over a predetermined frequency, then the periodic tracking is adjusted to be performed less frequently or more frequently than before.

8. The computer network system of claim 5, wherein, the AI SIP application creates an indication that a max-forward parameter used in the SIP is substituted with the AI max-forward parameter as a field value of an IPv4 packet header, an IPv6 packet header, or an SIP message header.
